(19) United States
(12) Patent Application Publication
(10) Pub. No.: US 2024/0407022 A1
(43) Pub. Date: Dec. 5, 2024

(54) MANAGING MULTICAST AND UNICAST DATA TRANSMISSION FOR MBS

(71) Applicant: GOOGLE LLC, Mountain View, CA (US)

(72) Inventor: Chih-Hsiang Wu, Taoyuan City (TW)

(21) Appl. No.: 18/694,142

(22) PCT Filed: Oct. 18, 2022
(86) PCT No.: PCT/US22/46953

§ 371 Date: Mar. 21, 2024

Related U.S. Application Data
(60) Provisional application No. 63/257,794, filed on Oct. 20, 2021.

(51) Int. Cl. H04W 76/12; H04W 76/40

(52) U.S. Cl. CPC H04W 76/12; H04W 76/40

(57) ABSTRACT

To manage multicast and unicast data transmissions. a base station receives. from a core network (CN), a multicast and/or broadcast services (MBS) downlink data packet via a downlink tunnel (602). The base station determines whether to transmit the MBS downlink data packet to a plurality of UEs via unicast or multicast. Then the base station transmits the MBS downlink data packet to a plurality of first UEs via a multicast data transmission (606), and/or transmits the MBS downlink data packet to a plurality of second UEs via a plurality of unicast data transmissions (608).

### CROSS-REFERENCE TO RELATED APPLICATIONS

This application claims priority to and the benefit of the filing date of U.S. Provisional Patent Application No. 63/257,794 entitled “Managing Multicast and Unicast Data Transmission for MBS,” filed on Oct. 20, 2021, the entire disclosure of which is hereby expressly incorporated by reference.

### FIELD OF THE DISCLOSURE

This disclosure relates to wireless communications and, more particularly, to enabling setup and/or modification of radio resources for multicast and/or broadcast communications.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP sublayer defined for the Evolved Universal Terrestrial Radio Access (EUTRA) radio interface (see Third Generation Partnership Project (3GPP) specification TS 36.323) and New Radio (NR) (sec 3GPP specification TS 38.323) provides sequencing of protocol data units (PDUs) in the uplink direction from a user device (also known as a user equipment or “UE”) to a base station, as well as in the downlink direction from the base station to the UE. The PDCP sublayer also provides services for signaling radio bearers (SRBs) to the Radio Resource Control (RRC) sublayer. The PDCP sublayer further provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

The UE in some scenarios can concurrently utilize resources of multiple nodes (e.g., base stations or components of a distributed base station or disaggregated base station) of a radio access network (RAN), interconnected by a backhaul. When these network nodes support different radio access technologies (RATs), this type of connectivity is referred to as multi-radio dual connectivity (MR-DC). When operating in MR-DC, the cell(s) associated with the base station operating as a master node (MN) define a master cell group (MCG), and the ce“lls associated with the base station operating as a secondary node (SN) define the secondary cell group (SCG). The MCG covers a primary cell (PCell) and zero, one, or more secondary cells (SCells), and the SCG covers a primary secondary cell (PSCell) and zero, one, or more SCells. The UE communicates with the MN (via the MCG) and the SN (via the SCG). In other scenarios, the UE utilizes resources of one base station at a time, in single connectivity (SC). The UE in SC only communicates with the MN, via the MCG. A base station and/or the UE determines when the UE should establish a radio connection with another base station. For example, a base station can determine to hand the UE over to another base station, and initiate a handover procedure. The UE in other scenarios can concurrently utilize resources of another RAN node (e.g., a base station or a component of a distributed or disaggregated base station), interconnected by a backhaul.

UEs can use several types of SRBs and DRBs. So-called “SRB1” resources carry RRC messages, which in some cases include NAS messages over the dedicated control channel (DCCH), and “SRB2” resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and can also be referred to as MCG SRBs. “SRB3” resources allow the UE and the SN to exchange RRC messages related to the SN, and can also be referred to as SCG SRBs. Split SRBs allow the UE to exchange RRC messages directly with the MN via lower-layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MN or SN but using the lower-layer resources of both the MN and the SN can be referred to as split DRBs. DRBs terminated at the MN but using the lower-layer resources of only the SN can be referred to as MN-terminated SCG DRBs. DRBs terminated at the SN but using the lower-layer resources of only the MN can be referred to as SN-terminated MCG DRBs.

UEs can perform handover procedures to switch from one cell to another, whether in SC or DC operation. These procedures involve messaging (e.g., RRC signaling and preparation) among RAN nodes and the UE. The UE may handover from a cell of a serving base station to a target cell of a target base station, or from a cell of a first distributed unit (DU) of a serving base station to a target cell of a second DU of the same base station, depending on the scenario. In DC scenarios, UEs can perform PSCell change procedures to change PSCells. These procedures involve messaging (e.g., RRC signaling and preparation) among RAN nodes and the UE. The UE may perform a PSCell change from a PSCell of a serving SN to a target PSCell of a target SN, or from a PSCell of a source DU of a base station to a PSCell of a target DU of the same base station, depending on the scenario. Further, the UE may perform handover or PSCell change within a cell for synchronous reconfiguration.

Base stations that operate according to fifth-generation (5G) New Radio (NR) requirements support significantly larger bandwidth than fourth-generation (4G) base stations. Accordingly, the Third Generation Partnership Project (3GPP) has proposed that for Release 15, user equipment units (UEs) support a 100 MHz bandwidth in frequency range 1 (FR1) and a 400 MHz bandwidth in frequency range (FR2). Due to the relatively wide bandwidth of a typical carrier in 5G NR. 3GPP has proposed for Release 17 that a 5G NR base station be able to provide multicast and/or broadcast service(s) (MBS) to UEs. MBS can be useful in many content delivery applications, such as transparent IPv4/IPv6 multicast delivery, IPTV, software delivery over wireless, group communications, Internet of Things (IoT) applications, V2X applications, and emergency messages related to public safety, for example.

5G NR provides both point-to-point (PTP) and point-to-multipoint (PTM) delivery methods for the transmission of MBS packet flows over the radio interface. In PTP communications, a RAN node transmits different copies of each MBS data packet to different UEs over the radio interface. On the other hand, in PTM communications, a RAN node transmits a single copy of each MBS data packet to multiple UEs over the radio interface. In some scenarios, however, it is unclear how a base station receives an MBS data packet from a core network and how the base station transmits each MBS data packet to one or more UEs.

### SUMMARY

Using the techniques of this disclosure, a core network (CN) and a base station communicate MBS traffic for multiple UEs via a shared (or “common”) tunnel between the CN and the base station. The base station can generate and provide the configuration of the common tunnel, such as an Internet Protocol (IP) address and/or a Tunnel Endpoint Identifier (TEID), to the CN in response to a request for the configuration from the CN. More generally, the configuration can include transport layer information.

The CN and base station can also communicate MBS traffic from multiple MBS sessions via multiple common tunnels between the CN and base station. For example, the CN and base station may establish one CN-to-BS tunnel for multiple MBS sessions or may establish a separate CN-to-BS tunnel for each MBS session.

The base station may also establish BS-to-UE transport(s) with the UE. The base station can communicate MBS traffic from multiple MBS sessions to the same UE using the same MBS radio bearer (MRB) associated with the MBS session. Alternatively, the base station can use different MRBs to communicate MBS traffic to the UE from each MBS session. More specifically, the base station maps traffic in a tunnel to radio bearers which may be configured as MRBs. Each of the MRBs may correspond to a respective MBS Traffic Channel (MTCH). In some scenarios, the base station communicates MBS traffic for an MBS session over a single MRB and corresponding MTCH to all of the UEs that joined the MBS session. In other scenarios, the base station communicates MBS traffic for an MBS session over DRBs corresponding to Dedicated Traffic Channels (DTCHs), where each DTCH is used to communicate MBS traffic with a particular one of the UEs that joined the MBS session.

The base station can determine whether to transmit an MBS data packet to UEs via unicast or multicast. For example, the base station can transmit the MBS data packet to a first set of UEs via multicast and a second set of UEs via unicast. In some implementations, the base station can determine whether to transmit an MBS data packet to UEs via unicast or multicast based on the tunnel from which the MBS data packet was received. The base station may store a mapping of each tunnel to a set of UEs for receiving the MBS data packet via multicast (e.g., as indicated by a G-RNTI), a set of UEs for receiving the MBS data packet via unicast (e.g., as indicated by C-RNTIs), an individual legacy UE for receiving the MBS data packet via unicast (e.g., as indicated by a C-RNTI), logical channel IDs corresponding to the tunnel, an MRB for the tunnel, a DRB for the tunnel, etc.

An example embodiment of these techniques is a method in a base station for managing multicast and unicast data transmissions. The method includes receiving, by processing hardware from a core network (CN), a multicast and/or broadcast services (MBS) downlink data packet via a downlink tunnel, and determining, by the processing hardware, whether to transmit the MBS downlink data packet to a plurality of UEs via unicast or multicast. The method further includes at least one of transmitting, by the processing hardware, the MBS downlink data packet to a plurality of first UEs via a multicast data transmission, or transmitting, by the processing hardware, the MBS downlink data packet to a plurality of second UEs via a plurality of unicast data transmissions.

Another example embodiment of these techniques is a method in a base station for managing transmission of MBS. The method includes receiving, by processing hardware from a UE, a first request to join a first MBS session identified by a first MBS session identifier, and receiving, by the processing hardware from the UE, a second request to join a second MBS session identified by a second MBS session identifier. Additionally, the method includes transmitting, by the processing hardware to the UE, first MBS data for the first MBS session, and transmitting, by the processing hardware to the UE, second MBS data for the second MBS session during the first MBS session.

Yet another example embodiment of these techniques is a base station including processing hardware and configured to implement one of the methods above.

Another example embodiment of these techniques is a method in a UE for obtaining multicast and/or broadcast services (MBS) data from a plurality of MBS sessions. The method includes transmitting, by processing hardware to a base station, a first request to join a first MBS session identified by a first MBS session identifier, and transmitting, by the processing hardware to the base station, a second request to join a second MBS session identified by a second MBS session identifier. Additionally, the method includes receiving. by the processing hardware from the base station, first MBS data for the first MBS session, and receiving, by the processing hardware from the base station, second MBS data for the second MBS session during the first MBS session.

Still another example embodiment of these techniques is a UE including processing hardware and configured to implement the method above.

### BRIEF DESCRIPTION OF THE DRAWINGS

FIG. 1A is a block diagram of an example system in which the techniques of this disclosure for managing multicast and unicast data transmission for MBS is disclosed;

FIG. 1B is a block diagram of an example base station in which a centralized unit (CU) and a distributed unit (DU) can operate in the system of FIG. 1A;

FIG. 2 is a block diagram of an example protocol stack according to which the UE of FIG. 1A can communicate with base stations of FIG. 1A;

FIG. 3 is a block diagram illustrating example tunnel architectures for MBS sessions and PDU sessions;

FIG. 4 is a block diagram illustrating example tunnel architectures for MRBs and DRBs;

FIG. 5A is a messaging diagram of an example scenario in which a CN and a base station establish a first common downlink (DL) tunnel to the base station via which the CN can transmit MBS data of a first MBS session, for a first UE, and establish a second common DL tunnel to the base station via which the CN can transmit MBS data of a second MBS session, for a second UE;

FIG. 5B is a messaging diagram of an example scenario in which a UE joins first and second MBS sessions, and a CN and a base station establish separate first and second common DL tunnels to the base station via which the CN can transmit MBS data of first and second MBS sessions, for the UE;

FIG. 6 is a flow diagram of an example method for identifying UEs to transmit an MBS data packet via multicast and/or identifying UE(s) to transmit the MBS data packet via unicast based on the tunnel via which the data packet was received, which can be implemented in a base station of FIG. 1A and/or a DU of FIG. 1B;

FIG. 7 is a flow diagram of an example method for determining which logical channel to use to transmit an MBS data packet to the UE(s) based on the tunnel via which the data packet was received, which can be implemented in a base station of FIG. 1A and/or a DU of FIG. 1B;

FIG. 8 is a flow diagram of an example method for determining which logical channels to use to transmit the MBS data packet to respective UEs based on the tunnel via which the data packet was received, which can be implemented in a base station of FIG. 1A and/or a DU of FIG. 1B;

FIG. 9 is a flow diagram of an example method for determining which logical channel to use and which G-RNTI to use when scrambling a cyclic redundancy check (CRC) of a downlink control information element (DCI) for transmitting to UEs the MBS data packet based on the tunnel via which the data packet was received, which can be implemented in a base station of FIG. 1A and/or a DU of FIG. 1B;

FIG. 10A is a flow diagram of an example method for determining which logical channel to use and whether to use N C-RNTIs to scramble N CRCs of N DCIs for transmitting to UEs a protocol data unit (PDU) including the MBS data packet based on the tunnel via which the data packet was received, which can be implemented in a base station of FIG. 1A and/or a DU of FIG. 1B;

FIG. 10B is a flow diagram of an example method for determining which logical channel to use and whether to use N C-RNTIs to scramble N CRCs of N DCIs for transmitting to UEs N PDUs including the MBS data packet based on the tunnel via which the data packet was received, which can be implemented in a base station of FIG. 1A and/or a DU of FIG. 1B;

FIG. 10C is a flow diagram of an example method for determining which logical channel to use and whether to use N C-RNTIs to scramble the same CRC of the same DCI for transmitting to UEs a PDU including the MBS data packet based on the tunnel via which the data packet was received, which can be implemented in a base station of FIG. 1A and/or a DU of FIG. 1B;

FIG. 11A is a flow diagram of another example method similar to the example method illustrated in FIG. 10A, which can be implemented in a base station of FIG. 1A and/or a DU of FIG. 1B;

FIG. 11B is a flow diagram of another example method similar to the example method illustrated in FIG. 10B, which can be implemented in a base station of FIG. 1A and/or a DU of FIG. 1B;

FIG. 11C is a flow diagram of another example method similar to the example method illustrated in FIG. 10C, which can be implemented in a base station of FIG. 1A and/or a DU of FIG. 1B;

FIG. 12 is a flow diagram of an example method for determining which logical channel to use and whether to use a C-RNTI to scramble a CRC of a DCI for transmitting to a particular UE the MBS data packet based on the tunnel via which the data packet was received, which can be implemented in a base station of FIG. 1A and/or a DU of FIG. 1B;

FIG. 13A is a flow diagram of an example method for determining which logical channel to use and whether to transmit an MBS data packet via unicast or multicast based on an MBS quality of service (QOS) flow ID associated with the MBS data packet, which can be implemented in a base station of FIG. 1A and/or a DU of FIG. 1B;

FIG. 13B is a flow diagram of an example method for determining which logical channel to use for transmitting an MBS data packet to UEs via unicast based on an MBS quality of service (QOS) flow ID associated with the MBS data packet, which can be implemented in a base station of FIG. 1A and/or a DU of FIG. 1B;

FIG. 14A is a flow diagram of another example method for determining which logical channel to use and whether to transmit an MBS data packet via unicast or multicast based on an MBS quality of service (QOS) flow ID associated with the MBS data packet similar to the method illustrated in FIG. 13A, which can be implemented in a base station of FIG. 1A and/or a DU of FIG. 1B;

FIG. 14B is a flow diagram of another example method for determining which logical channel to use for transmitting an MBS data packet to UEs via unicast based on an MBS quality of service (QOS) flow ID associated with the MBS data packet similar to the method illustrated in FIG. 13B, which can be implemented in a base station of FIG. 1A and/or a DU of FIG. 1B; and

FIG. 15 is a flow diagram of an example method for configuring DL transport layer configurations and identifying UEs to receive an MBS data packet via multicast and/or identifying UE(s) to receive the MBS data packet via unicast based on particular transport layer information associated with the MBS data packet, which can be implemented in a base station of FIG. 1A and/or a DU of FIG. 1B.

### DETAILED DESCRIPTION OF THE DRAWINGS

Generally speaking, a RAN and/or a CN implement the techniques of this disclosure to manage multicast and unicast data transmission. The base station can determine whether to transmit an MBS data packet to UEs via unicast or multicast. For example, the base station can transmit the MBS data packet to a first set of UEs via multicast and a second set of UEs via unicast.

In some implementations, the base station can determine whether to transmit the MBS data packet to UEs via unicast or multicast according to an MBS quality of service (QoS) flow associated with the MBS data packet. For example, if the QoS flow ID associated with the MBS data packet is a first QoS flow ID, the base station may transmit the MBS data packet to the UEs via multicast. Otherwise, if the QoS flow ID associated with the MBS data packet is a second QoS flow ID, the base station may transmit the MBS data packet to the UEs via unicast. In other implementations, the base station can determine the logical channel ID for the MBS data packet based on the QoS flow. For example, the base station may identify or select a first logical channel ID if the QoS flow ID associated with the MBS data packet is a first QoS flow ID and a second logical channel ID if the QoS flow ID associated with the MBS data packet is a second QoS flow ID.

Also in some implementations, the base station may configure DL transport layer configurations corresponding to common DL tunnels for receiving MBS data packets from the CN. When an MBS data packet is received at the base station from the CN for example, the base station identifies the transport layer information included in a DL tunnel packet that includes the MBS data packet. Then the base station may identify the tunnel from which the MBS data packet was received based on the transport layer information. For example, the transport layer information may include a transport layer address, such as an IP address or a TEID.

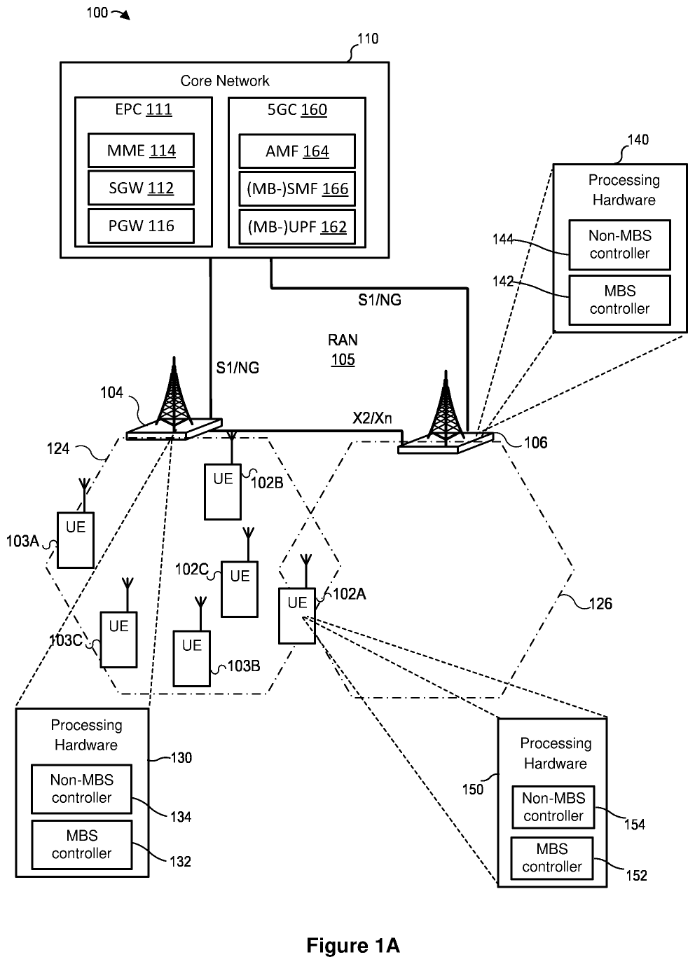

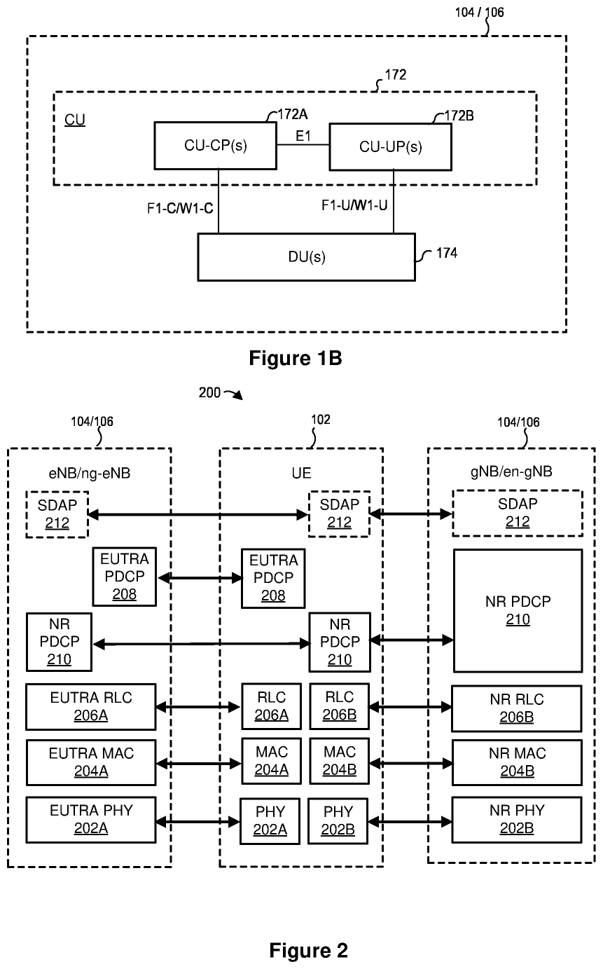

FIG. 1A depicts an example wireless communication system 100 in which techniques of this disclosure for managing transmission and reception of multicast and/or broadcast services (MBS) information can be implemented. The wireless communication system 100 includes user equipment (UEs) 102A-103C as well as base stations 104, 106 of a radio access network (RAN) 105 connected to a core network (CN) 110. In other implementations or scenarios, the wireless communication system 100 may instead include more or fewer UEs, and/or more or fewer base stations, than are shown in FIG. 1A. The base stations 104, 106 can be of any suitable type, or types, of base stations, such as an evolved node B (eNB), a next-generation eNB (ng-eNB), or a 5G Node B (gNB), for example. As a more specific example, the base station 104 may be an eNB or a gNB, and the base stations 106 may be a gNB.

The base station 104 supports a cell 124, and the base station 106 supports a cell 126. The cell 124 partially overlaps with the cell 126, so that the UE 102A can be in range to communicate with base station 104 while simultaneously being in range to communicate with the base station 106 (or in range to detect or measure signals from the base station 106). The overlap can make it possible for the UE 102A to hand over between the cells (e.g., from the cell 124 to the cell 126) or base stations (e.g., from the base station 104 to the base station 106) before the UE 102A experiences radio link failure, for example. Moreover, the overlap allows the various dual connectivity (DC) scenarios. For example, the UE 102A can communicate in DC with the base station 104 (operating as a master node (MN)) and the base station 106 (operating as a secondary node (SN)). When the UE 102A is in DC with the base station 104 and the base station 106, the base station 104 operates as a master eNB (MeNB), a master ng-eNB (Mng-eNB), or a master gNB (MgNB), and the base station 106 operates as a secondary gNB (SgNB) or a secondary ng-eNB (Sng-eNB).

In non-MBS (unicast) operation, the UE 102A can use a radio bearer (e.g., a DRB or an SRB)) that at different times terminates at an MN (e.g., the base station 104) or an SN (e.g., the base station 106). For example, after handover or SN change to the base station 106, the UE 102A can use a radio bearer (e.g., a DRB or an SRB) that terminates at the base station 106. The UE 102A can apply one or more security keys when communicating on the radio bearer, in the uplink (from the UE 102A to a base station) and/or downlink (from a base station to the UE 102A) direction. In non-MBS operation, the UE 102A transmits data via the radio bearer on (i.e., within) an uplink (UL) bandwidth part (BWP) of a cell to the base station, and/or receives data via the radio bearer on a downlink (DL) BWP of the cell from the base station. The UL BWP can be an initial UL BWP or a dedicated UL BWP, and the DL BWP can be an initial DL BWP or a dedicated DL BWP. The UE 102A can receive paging, system information, public warning message(s), or a random access response on the DL BWP. In this non-MBS operation, the UE 102A can be in a connected state. Alternatively, the UE 102A can be in an idle or inactive state if the UE 102A supports small data transmission in the idle or inactive state.

In MBS operation, the UE 102A can use an MBS radio bearer (MRB) that at different times terminates at an MN (e.g., the base station 104) or an SN (e.g., the base station 106). For example, after handover or SN change, the UE 102A can use an MRB that terminates at the base station 106, which can be operating as an MN or SN. In some scenarios, a base station (e.g., the MN or SN) can transmit MBS data over unicast radio resources (i.e., the radio resources dedicated to the UE 102A) to the UE 102A via the MRB. In other scenarios, the base station (e.g., the MN or SN) can transmit MBS data over multicast radio resources (i.e., the radio resources common to the UE 102A and one or more other UEs), or a DL BWP of a cell from the base station to the UE 102A via the MRB. The DL BWP can be an initial DL BWP, a dedicated DL BWP, or an MBS DL BWP (i.e., a DL BWP that is specific to MBS, or not for unicast).

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation of FIG. 1A includes an MBS controller 132 that is configured to manage or control transmission of MBS information received from the CN 110 or an edge server. For example, the MBS controller 132 can be configured to support radio resource control (RRC) configurations, procedures and messaging associated with MBS procedures, and/or other operations associated with those configurations and/or procedures, as discussed below. The processing hardware 130 can also include a non-MBS controller 134 that is configured to manage or control one or more RRC configurations and/or RRC procedures when the base station 104 operates as an MN or SN during a non-MBS operation.

The base station 106 includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes an MBS controller 142 and a non-MBS controller 144, which may be similar to the controllers 132 and 134, respectively, of base station 130. Although not shown in FIG. 1A, the RAN 105 can include additional base stations with processing hardware similar to the processing hardware 130 of the base station 104 and/or the processing hardware 140 of the base station 106.

The UE 102A includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes an MBS controller 152 that is configured to manage or control reception of MBS information. For example, the UE MBS controller 152 can be configured to support RRC configurations, procedures and messaging associated with MBS procedures, and/or other operations associated with those configurations and/or procedures, as discussed below. The processing hardware 150 can also include a non-MBS controller 154 configured to manage or control one or more RRC configurations and/or RRC procedures in accordance with any of the implementations discussed below, when the UE 102A communicates with an MN and/or an SN during a non-MBS operation. Although not shown in FIG. 1A, UEs 102B-103C may include processing hardware similar to the processing hardware 150 of the UE 102A.

The CN 110 may be an evolved packet core (EPC) 111 or a fifth-generation core (5GC) 160, both of which are depicted in FIG. 1A. The base station 104 may be an eNB supporting an SI interface for communicating with the EPC 111, an ng-eNB supporting an NG interface for communicating with the 5GC 160, or a gNB that supports an NR radio interface as well as an NG interface for communicating with the 5GC 160. The base station 106 may be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104 and 106 may support an X2 or Xn interface.

Among other components, the EPC 111 can include a serving gateway (SGW) 112, a mobility management entity (MME) 114, and a packet data network gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from a UE (e.g., UE 102A or 102B) to one or more external packet data networks, e.g., an Internet network and/or an Internet Protocol (IP) Multimedia Subsystem (IMS) network. The 5GC 160 includes a user plane function (UPF) 162 and an access and mobility management (AMF) 164, and/or a session management function (SMF) 166. The UPF 162 is generally configured to transfer user-plane packets related to audio calls, video calls, Internet traffic, etc., the AMF 164 is generally configured to manage authentication, registration, paging, and other related functions, and the SMF 166 is generally configured to manage PDU sessions.

The UPF 162, AMF 164, and/or SMF 166 can be configured to support MBS. For example, the SMF 166 can be configured to manage or control MBS transport, configure the UPF 162 and/or RAN 105 for MBS flows, and/or manage or configure one or more MBS sessions or PDU sessions for MBS for a UE (e.g., UE 102A or 102B). The UPF 162 is configured to transfer MBS data packets to audio, video, Internet traffic, etc. to the RAN 105. The UPF 162 and/or SMF 166 can be configured for both non-MBS unicast service and MBS, or for MBS only.

Generally, the wireless communication system 100 may include any suitable number of base stations supporting NR cells and/or EUTRA cells. More particularly, the EPC 111 or the 5GC 160 may be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies, such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, and the base station 106 can operate as an SgNB or an Sng-eNB. The UE 102A can communicate with the base station 104 and the base station 106 via the same radio access technology (RAT), such as EUTRA or NR, or via different RATs.

When the base station 104 is an MeNB and the base station 106 is an SgNB, the UE 102A can be in EN-DC with the MeNB 104 and the SgNB 106. When the base station 104 is an Mng-eNB and the base station 106 is an SgNB, the UE 102A can be in next generation (NG) EUTRA-NR DC (NGEN-DC) with the Mng-eNB 104 and the SgNB 106. When the base station 104 is an MgNB and the base station 106 is an SgNB, the UE 102A can be in NR-NR DC (NR-DC) with the MgNB 104 and the SgNB 106. When the base station 104 is an MgNB and the base station 106 is an Sng-eNB, the UE 102A can be in NR-EUTRA DC (NE-DC) with the MgNB 104 and the Sng-eNB 106.

FIG. 1B depicts an example distributed implementation of any one or more of the base stations 104 and 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include some or all of the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 104) operates as an MN or an SN. The processing hardware can also include a physical (PHY) layer controller configured to manage or control one or more PHY layer operations or procedures.

In some implementations, the CU 172 can include one or more logical nodes (CU-CP(s) 172A) that host the control plane part of the Packet Data Convergence Protocol (PDCP) protocol of the CU 172 and/or the radio resource control (RRC) protocol of the CU 172. The CU 172 can also include one or more logical nodes (CU-UP(s) 172B) that host the user plane part of the PDCP protocol and/or service data adaptation protocol (SDAP) protocol of the CU 172. The CU-CP(s) 172A can transmit non-MBS control information and MBS control information, and the CU-UP(s) 172B can transmit non-MBS data packets and MBS data packets, as described herein.

The CU-CP(s) 172A can be connected to multiple CU-UPs 172B through the E1interface. The CU-CP(s) 172A select the appropriate CU-UP(s) 172B for the requested services for the UE 102A. In some implementations, a single CU-UP 172B can be connected to multiple CU-CPs 172A through the E1 interface. A CU-CP 172A can be connected to one or more DUs 174s through an F1-C interface. A CU-UP 172B can be connected to one or more DUs 174 through an F1-U interface under the control of the same CU-CP 172A. In some implementations, one DU 174 can be connected to multiple CU-UPs 172B under the control of the same CU-CP 172A. In such implementations, the connectivity between a CU-UP 172B and a DU 174 is established by the CU-CP 172A using bearer context management functions.

FIG. 2 illustrates, in a simplified manner, an example protocol stack 200 according to which a UE (e.g., UE 102A or 102B) can communicate with an eNB/ng-eNB or a gNB (e.g., one or more of the base stations 104, 106). In the example protocol stack 200, a PHY sublayer 202A of EUTRA provides transport channels to an EUTRA MAC sublayer 204A, which in turn provides logical channels to an EUTRA RLC sublayer 206A. The EUTRA RLC sublayer 206A in turn provides RLC channels to an EUTRA PDCP sublayer 208 and, in some cases, to an NR PDCP sublayer 210. Similarly, an NR PHY 202B provides transport channels to an NR MAC sublayer 204B, which in turn provides logical channels to an NR RLC sublayer 206B. The NR RLC sublayer 206B in turn provides RLC channels to an NR PDCP sublayer 210. The UE 102A, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102A can support layering of NR PDCP 210 over EUTRA RLC 206A, and an SDAP sublayer 212 over the NR PDCP sublayer 210. Sublayers are also referred to herein as simply “layers.”

The EUTRA PDCP sublayer 208 and the NR PDCP sublayer 210 receive packets (e.g., from an IP layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.” The packets can be MBS packets or non-MBS packets. MBS packets may include application content for an MBS service (e.g., IPv4/IPv6 multicast delivery, IPTV, software delivery over wireless, group communications, IoT applications, V2X applications, and/or emergency messages related to public safety), for example. As another example, MBS packets may include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 may be SDAP PDUs, IP packets, or Ethernet packets, for example.

In scenarios where the UE 102A or 102B operates in EN-DC with the base station 104 operating as an MeNB and the base station 106 operating as an SgNB, the wireless communication system 100 can provide the UE 102A or 102B with an MN-terminated bearer that uses EUTRA PDCP sublayer 208, or an MN-terminated bearer that uses NR PDCP sublayer 210. The wireless communication system 100 in various scenarios can also provide the UE 102A or 102B with an SN-terminated bearer, which uses only the NR PDCP sublayer 210. The MN-terminated bearer may be an MCG bearer, a split bearer, or an MN-terminated SCG bearer. The SN-terminated bearer may be an SCG bearer, a split bearer, or an SN-terminated MCG bearer. The MN-terminated bearer may be an SRB (e.g., SRB1 or SRB2) or a DRB. The SN-terminated bearer may be an SRB or a DRB.

In some implementations, a base station (e.g., base station 104, 106) broadcasts MBS data packets via one or more MBS radio bearers (MRB(s)), and in turn the UE 102A receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE 102A uses PHY sublayer 202, MAC sublayer 204, and RLC sublayer 206 to receive the MBS data packets. In such implementations, the base station and the UE 102A may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE 102A uses PHY sublayer 202, MAC sublayer 204, RLC sublayer 206 and PDCP sublayer 208 to receive the MBS data packets. In such implementations, the base station and the UE 102A may not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204, and PHY sublayer 202 and, correspondingly, the UE 102A uses the PHY sublayer 202, MAC sublayer 204, RLC sublayer 206, PDCP sublayer 208, and SDAP sublayer 212 to receive the MBS data packets.

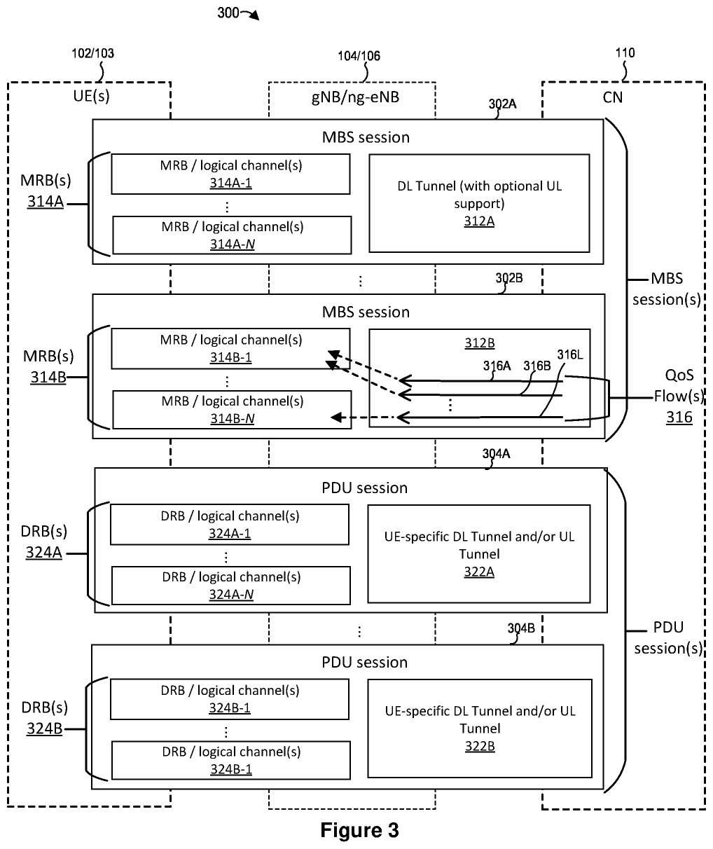

Referring to FIG. 3, an MBS session 302A can include a tunnel 312A with endpoints at the CN 110 and the base station 104/106. The MBS session 302A can correspond to a certain session ID such as a Temporary Mobile Group Identity (TMGI), for example. The MBS data can include IP packets, TCP/IP packets, UDP/IP packets, Real-Time Transport Protocol (RTP)/UDP/IP packets, or RTP/TCP/IP packets, for example.

In some cases, the CN 110 and/or the base station 104/106 configure the tunnel 312A only for MBS traffic directed from the CN 110 to the base station 104/106, and the tunnel 312A can be referred to as a downlink (DL) tunnel. In other cases, however, CN 110 and the base station 104/106 use the tunnel 312A for downlink as well as for uplink (UL) MBS traffic to support, for example, commands or service requests from the UEs. Further, because the base station 104/106 can direct MBS traffic arriving via the tunnel 312A to multiple UEs, the tunnel 312A can be referred to as a common tunnel or a common DL tunnel.

The tunnel 312A can operate at the transport layer or sublayer, e.g., on the User Datagram Protocol (UDP) protocol layered over Internet Protocol (IP). As a more specific example, the tunnel 312A can be associated with the General Packet Radio System (GPRS) Tunneling Protocol (GTP). The tunnel 312A can correspond to a certain IP address (e.g., an IP address of the base station 104/106) and a certain Tunnel Endpoint Identifier (TEID) (e.g., assigned by the base station 104/106), for example. More generally, the tunnel 312A can have any suitable transport-layer configuration. The CN 110 can specify the IP address and the TEID address in header(s) of a tunnel packet including an MBS data packet and transmit the tunnel packet downstream to the base station 104/106 via the tunnel 312A. The header(s) can include the IP address and/or the TEID. For example, the header(s) includes an IP header and an GTP header including the IP address and the TEID, respectively. The base station 104/106 accordingly can identify data packets traveling via the tunnel 312A using the IP address and/or the TEID.

As illustrated in FIG. 3, the base station 104/106 maps traffic in the tunnel 312A to N radio bearers 314A-1. 314A-2 . . . 314A-N, which may be configured as MBS radio bearers or MRBs, where N≥1. Each MRB can correspond to a respective logical channel. As discussed above, the PDCP sublayer provides support for radio bearers such as SRBs, DRBs, and MRBs, and a EUTRA or NR MAC sublayer provides logical channels to a EUTRA or NR RLC sublayer. Each of the MRBs 314A for example can correspond to a respective MBS Traffic Channel (MTCH). The base station 104/106 and the CN 110 can also maintain another MBS session 302B, which similarly can include a tunnel 312B corresponding to MRBs 314B-1, 314B-2, . . . 314B-N, where N≥1. Each of the MRBs 314B can correspond to a respective logical channel.

The MBS traffic can include one or multiple quality-of-service (QOS) flows, for each of the tunnels 312A, 312B, etc. For example, the MBS traffic on the tunnel 312B can include a set of flows 316 including QoS flows 316A, 316B, . . . 316L. Further, a logical channel of an MRB can support a single QoS flow or multiple QoS flows. In the example configuration of FIG. 3, the base station 104/106 maps the QoS flows 316A and 316B to the MTCH of the MRB 314B-1, and the QoS flow 316L to the MTCH of the MRB 314B-N.

In various scenarios, the CN 110 can assign different types of MBS traffic to different QoS flows. A flow with a relatively high QoS value can correspond to audio packets, and a flow with a relatively low QoS value can correspond to video packets, for example. As another example, a flow with a relatively high QoS value can correspond to I-frames or complete images used in video compression, and a flow with a relatively low QoS value can correspond to P-frames or predicted pictures that include only changes to I-frames.

With continued reference to FIG. 3, the base station 104/106 and the CN 110 can maintain one or more PDU sessions to support unicast traffic between the CN 110 and particular UEs. A PDU session 304A can include a UE-specific DL tunnel and/or UE-specific UL tunnel 322A corresponding to one or more DRBs 324A, such as a DRB 324A-1, 324A-2, . . . 324-N. Each of the DRBs 324A can correspond to a respective logical channel, such as a Dedicated Traffic Channel (DTCH).

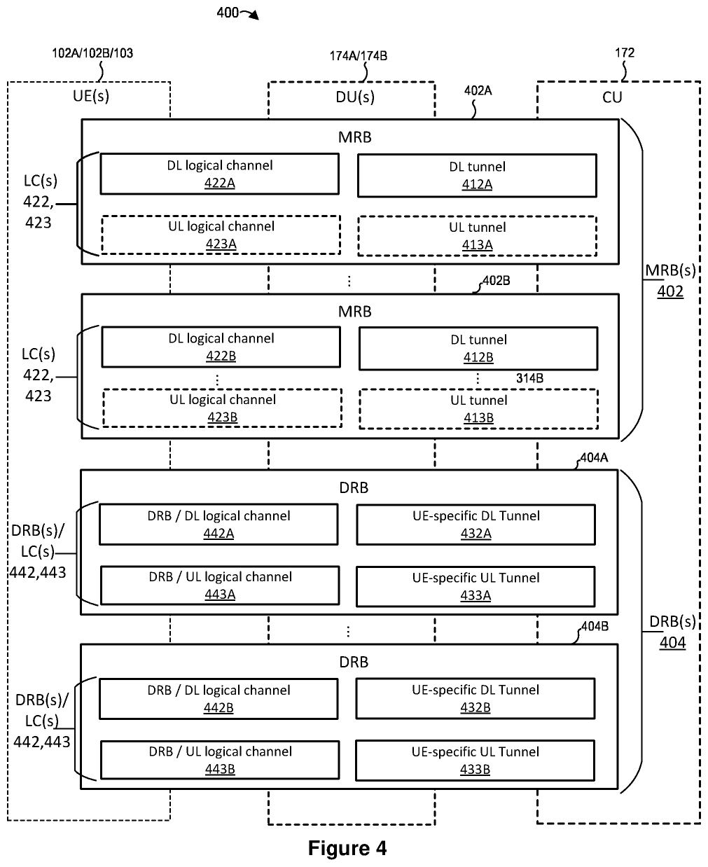

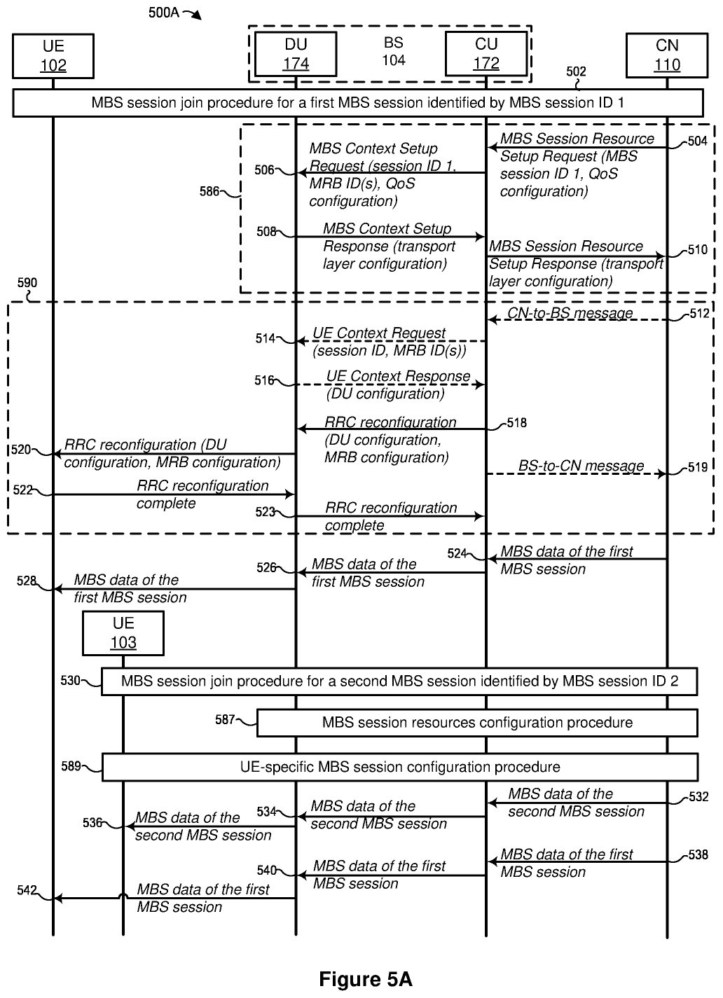

Now referring to FIG. 4, when the base station 104/106 is implemented in a distributed manner, the CU 172 and the DU 174A/174B can establish tunnels for downlink data and/or uplink data associated with an MRB or a DRB. The MRB 314A-1 discussed above can be implemented as an MRB 402A connecting the CU 172 to multiple UEs such as the UE 102A and 102B, for example. The MRB 402A can include a DL tunnel 412A connecting the CU 172 and the DU 174A/174B, and a DL logical channel 422A corresponding to the DL tunnel 412A. In particular, the DU 174A/174B can map downlink traffic received via the DL tunnel 412A to the DL logical channel 422A, which can be an MTCH or a DTCH, for example. The DL tunnel 412A can be a common DL tunnel via which the CU 172 transmits MBS data packets to multiple UEs. Alternatively, the DL tunnel 412A can be a UE-specific DL tunnel via which the CU 172 transmits MBS data packets to a particular UE.

Optionally, the MRB 402A also includes a UL tunnel 413A connecting the CU 172 and the DU 174A/174B, and a UL logical channel 423A corresponding to the UL tunnel 413A. The UL logical channel 423A can be a DTCH, for example. The DU 174A/174B can map uplink traffic received via the UL logical channel 423A to the UL tunnel 413A.

The tunnels 412A and 413A can operate at the transport layer or sublayer of the F1-U interface. As a more specific example, the CU 172 and the DU 174A/174B can utilize an F1-U for user-plane traffic, and the tunnels 412A and 413A can be associated with the GTP-U protocol layered over UDP/IP, where IP is layered over suitable data link and physical (PHY) layers. Further, the MRB(s) 402 and/or the DRB(s) 404 in at least some of the cases additionally support control-plane traffic. More particularly, the CU 172 and the DU 174A/174B can exchange F1-AP messages over an F1-C interface that relies on a Stream Control Transmission Protocol (SCTP) layered over IP, where IP is layered over suitable data link and PHY layers similar to F1-U.

Similarly, an MRB 402B can include a DL tunnel 412B and, optionally, an UL tunnel 413B. The DL tunnel 412B can correspond to a DL logical channel 422B, and the UL tunnel 413B can correspond to the UL logical channel 423B.

The CU 172 in some cases uses a DRB 404A to transmit MBS data packets or unicast data packets associated with a PDU session, to a particular UE (e.g., the UE 102A or the UE 102B). The DRB 404A can include a UE-specific DL tunnel 432A connecting the CU 172 and the DU 174A/174B, and a DL logical channel 442A corresponding to the DL tunnel 432A. In particular, the DU 174A/174B can map downlink traffic received via the DL tunnel 432A to the DL logical channel 442A, which can be a DTCH, for example. The DRB 404A further includes a UE-specific UL tunnel 433A connecting the CU 172 and the DU 174A/174B, and a UL logical channel 443A corresponding to the UL tunnel 433A. The UL logical channel 443A can be a PUSCH, for example. The DU 174A/174B can map uplink traffic received via the UL logical channel 443A to the UL tunnel 433A.

Similarly, a DRB 404B can include a UE-specific DL tunnel 432B corresponding to a DL logical channel 442B, and a UE-specific UL tunnel 433B corresponding to a UL logical channel 443B.

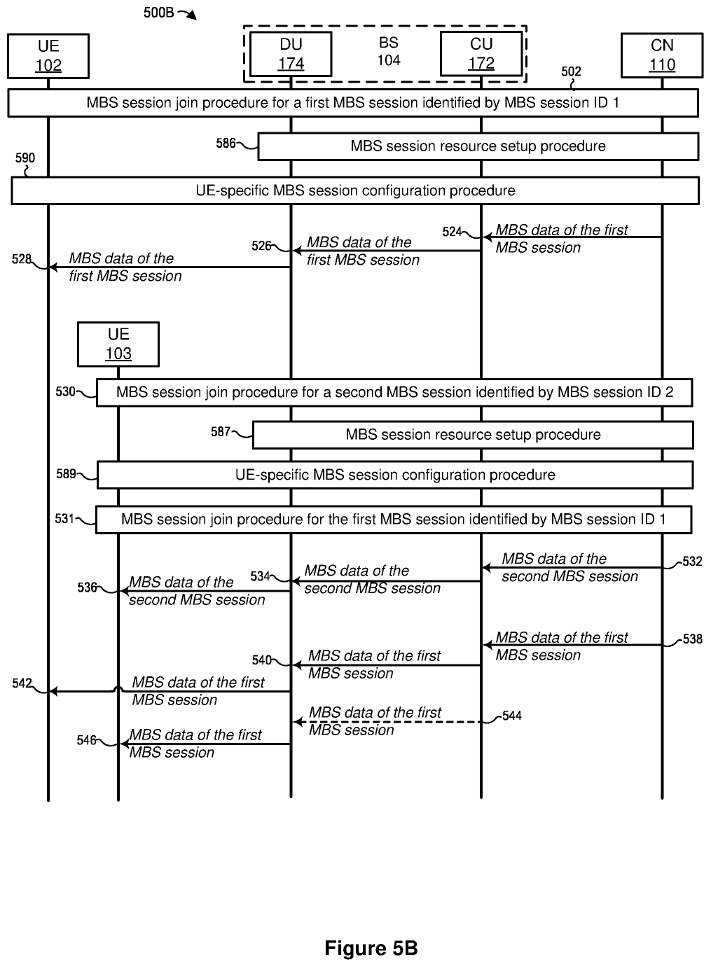

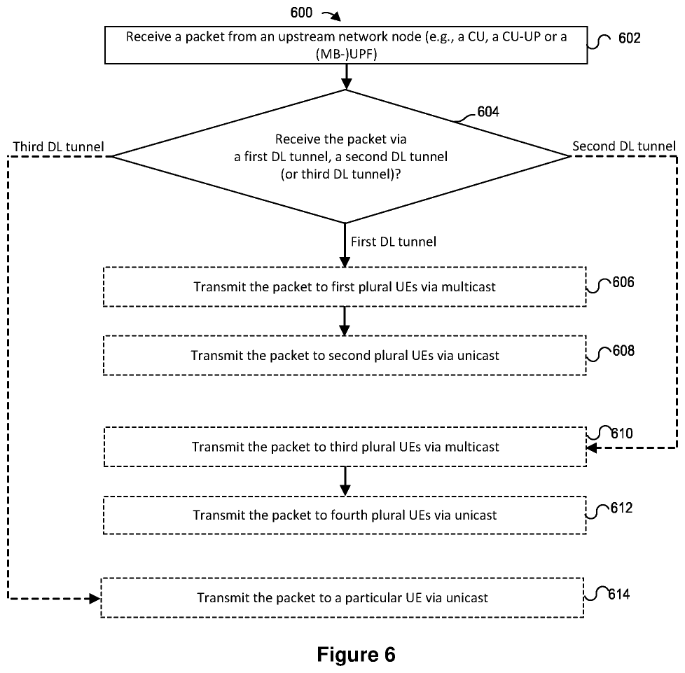

Next, FIG. 5A illustrates an example scenario 500A in which the base station 104 configures a first common tunnel for MBS data in response to the CN requesting resources for a first MBS session and configures a second common tunnel for MBS data in response to the CN requesting resources for a second MBS session.

The UE 102 initially performs 502 an MBS session join procedure with the CN 110 via the base station 104 to join a first MBS session. In some scenarios, the UE 102 subsequently performs additional one or more MBS join procedures, and event 502 accordingly is a first one of multiple MBS join procedures. Because the base station 104 configures a common DL tunnel for MBS traffic rather than a UE-specific tunnel, as discussed below, the procedures 502 and 590 can occur in either order. In other words, the base station 104 can configure a common DL tunnel before even a single UE joins the first MBS session.

To perform the MBS session join procedure, the UE 102 in some implementations sends a MBS session join request message to the CN 110 via the base station 104. In response, the CN 110 can send an MBS session join response message to the UE 102 via the base station 104 to grant the UE 102 access to the first MBS session. In some implementations, the UE 102 can include a first MBS session ID for the first MBS session in the MBS session join request message. The CN 110 in some cases includes the first MBS session ID in the MBS session join response message. In some implementations, the UE 102 can send an MBS session join complete message to the CN 110 via the base station 104 in response to the MBS session join response message.

The UE 102 in some cases performs additional MBS session join procedure(s) with the CN 110 via the RAN 105 (e.g., the base station 104 or base station 106) to join additional MBS session(s). For example, the UE 102 can perform a second MBS session join procedure with the CN 110 via the RAN 105 to join a second MBS session. Similar to event 502, the UE 102 in some implementations can send a second MBS session join request message to the CN 110 via the base station 104, and the CN 110 can respond with a second MBS session join response message to grant the UE 102 access to the second MBS session. In some implementations, the UE 102 can send a second MBS session join complete message to the CN 110 via the base station 104 in response to the second MBS session join response message. In some implementations, the UE 102 can include a second MBS session ID of the second MBS session in the second MBS session join request message. The CN 110 optionally includes the second MBS session ID in the second MBS session join response message. In some implementations, the UE 102 can include the first and second MBS session IDs in an MBS session join request message (e.g., the first MBS session join request message) to join the first and second MBS sessions at the same time. In such cases, the CN 110 can send an MBS session response message to grant either the first MBS session or the second MBS session, or both the first and MBS sessions.

In some implementations, the MBS session join request message, MBS session join response message and MBS session join complete message can be session initiation protocol (SIP) messages. In other implementations, the MBS session join request message, MBS session join response message and MBS session join complete message can be NAS messages such as 5G mobility management (5GMM) messages or 5G session management messages (5GSM). In case of the 5GSM messages, the UE 102 can transmit to the CN 110 via the base station 104 a (first) UL container message including the MBS session join request message, the CN 110 can transmit to the UE 102 via the base station 104 a DL container message including the MBS session join response message, and the UE 102 can transmit to the CN 110 via the base station 104 a (second) UL container message including the MBS session join complete message. These container messages can be 5GMM messages. In some implementations, the MBS session join request message, MBS session join response and MBS session join complete message can be a PDU Session Modification Request message, a PDU Session Modification Command message and a PDU Session Modification Complete message, respectively. To simplify the following description, the MBS session join request message, the MBS session join response message and/or the MBS session join complete message can represent the container messages.

In some implementations, the UE 102 can perform a PDU session establishment procedure with the CN 110 via the base station 104 to establish a PDU session in order to perform the (first) MBS session join procedure. During the PDU session establishment procedure, the UE 102 can communicate a PDU session ID of the PDU session with the CN 110 via the base station 104.

Before, during, or after the first MBS session join procedure (event 502), the CN 110 can send 504 a (first) CN-to-BS message including the first MBS session ID and/or PDU session ID to the CU 172 to request the CU 172 to configure resources for the first MBS session. The CN 110 can additionally include quality of service (QOS) configuration(s) for the first MBS session in the first CN-to-BS message. In response to receiving 504 the first CN-to-BS message, the CU 172 sends 506 a CU-to-DU message (e.g., an MBS Context Setup Request message) to the DU 174 to request a set-up for an MBS context and/or a common DL tunnel for the first MBS session. The MBS Context Setup Request message may include the first MBS session ID, MRB ID(s), and QoS configuration(s) for the first MBS session.

In response to receiving 506 the CU-to-DU message, the DU 174 sends 508, to the CU, a DU-to-CU message (e.g., an MBS Context Setup Response message) including a first DL transport layer configuration to configure a common CU-to-DU DL tunnel for the first MBS session (e.g., for a MRB identified by one of the MRB ID(s)). The DU 174 can include, in the DU-to-CU message, additional DL transport layer configuration(s) to configure additional common CU-to-DU DL tunnel(s) for additional MRB(s) identified by additional MRB ID(s) of the MRB IDs. In some implementations, the DU 174 can include, in the DU-to-CU message, the MRB ID(s) associated with the first DL transport layer configuration and/or the additional DL transport layer configuration(s). In some implementations, the CU-to-DU message is a generic F1AP message or a dedicated F1AP message defined specifically to convey this type of a request (e.g., an MBS Context Setup Request message). In some implementations, the DU-to-CU message of event 508 is a generic F1AP message or a dedicated F1AP message defined specifically for this purpose (e.g., an MBS Context Setup Response message). The CN 110 can additionally include quality of service (QOS) configuration(s) for the first MBS session. In such cases, the CU 172 can include the QoS configuration(s) in the CU-to-DU message (event 506).

The CU 172 can then send 510 a first BS-to-CN message (e.g., an MBS Session Resource Setup Response message) including the DL transport layer configuration to configure the common DL tunnel. The CU 172 can include the first MBS session ID and/or the PDU session ID in the first BS-to-CN message. The first BS-to-CN message can include a DL transport layer configuration to configure a common DL tunnel for the CN 110 to send MBS data to the CU 172. The DL transport layer configuration includes a transport layer address (e.g., an IP address and/or a TEID) to identify the common DL tunnel.

In some implementations, the CN-to-BS message of event 504 can be a generic NGAP message or a dedicated NGAP message defined specifically for requesting resources for an MBS session (e.g., MBS Session Resource Setup Request message). In some implementations, the BS-to-CN message of event 510 is a generic NGAP message or a dedicated NGAP message defined specifically to convey resources for an MBS session (e.g., MBS Session Resource Setup Response message). In such cases, the CN-to-BS message of event 504 and the BS-to-CN message of event 510 can be non-UE-specific messages.

In some implementations, the QoS configuration(s) include QoS parameters for the first MBS session. In some implementations, the QoS configuration includes configuration parameters to configure one or more QoS flows for the MBS session (see FIG. 3). In some implementations, the configuration parameters include one or more QoS flow IDs identifying the QoS flow(s). Each of the QoS flow ID(s) identifies a particular QOS flow of the QoS flow(s). In some implementations, the configuration parameters include QoS parameters for each QoS flow. The QoS parameters can include a 5G QoS identifier (5QI), a priority level, packet delay budget, packet error rate, averaging window and/or a maximum data burst volume. The CN 110 can specify different values of the QoS parameters for the QoS flows.

The events 504, 506, 508, and 510 are collectively referred to in FIGS. 5A and 5B as an MBS session resource setup procedure 586.

In cases where the CN 110 grants the additional MBS session(s) for the UE 102 in the additional MBS session join procedure(s), the CN 110 can include the additional MBS session ID(s) and/or QoS configuration(s) for the additional MBS session ID(s) in the first CN-to-BS message, the second CN-to-BS message, or additional CN-to-BS message(s) similar to the first or second CN-to-BS message. In such cases, the CU 172 includes additional transport layer configuration(s) for the additional MBS session(s) to configure additional common DL tunnel(s) in the first BS-to-CN message, the second BS-to-CN message, or additional BS-to-CN message(s) similar to the first or second BS-to-CN message. Each of the transport layer configuration(s) configures a particular DL tunnel of the common DL tunnel(s) and can be associated to a particular MBS session of the additional MBS session(s). Alternatively, the CN 110 can perform additional MBS session resource setup procedure(s) with the CU 172 to obtain the additional transport layer configuration(s) from the CU 172, similar to the single-session MBS session resource setup procedure 586. The transport layer configurations can be different to distinguish between different common DL tunnel. In particular, any pair of the transport layer configurations can have different IP addresses, different DL TEIDs, or different IP addresses as well as different DL TEIDs.

In some implementations, the CN 110 can indicate, in the CN-to-BS message of event 504, a list of UEs joining the first MBS session. In other implementations, the CN 110 can send 512 to the CU 172 another, second CN-to-BS message indicating a list of UEs joining the first MBS session. The CN 110 can include the first MBS session ID and/or the PDU session ID in the second CN-to-BS message. The CU 172 can send 519 a second BS-to-CN message to the CN 110 in response to the second CN-to-BS message 512. In such cases, the second CN-to-BS message can be a non-UE-specific message, i.e., a message not specific for the UE 102A or the UE 102B. The CU 172 can include the first MBS session ID and/or the PDU session ID in the second BS-to-CN message. For example, the list of UEs includes the UE 102. To indicate a list of UEs, the CN 110 can include a list of (CN UE interface ID, RAN UE interface ID) pairs, each identifying a particular UE of the UEs. The CN 110 assigns the CN UE interface ID, and the CU 172 assigns the RAN UE interface ID. Before the CN 110 sends the list of (CN UE interface ID, RAN UE interface ID) pairs, the CU 172 sends a BS-to-CN message (e.g., a NGAP message, an INITIAL UE MESSAGE or PATH SWITCH REQUEST message) including the RAN UE interface ID to the CN 110 for each of the UEs, and the CN 110 sends a CN-to-BS message (e.g., a NGAP message, an INITIAL CONTEXT SETUP REQUEST message or PATH SWITCH REQUEST ACKNOWLEDGE message) including the CN UE interface ID to the CU 172 for each of the UEs. In one example, the list of pairs includes a first pair (a first CN UE interface ID and a first RAN UE interface ID) identifying the UE 102. In some implementations, the “CN UE interface ID” can be a “AMF UE NGAP ID” and the “RAN UE interface ID” can be a “RAN UE NGAP ID.” In other implementations, the CN 110 can include a list of UE IDs, each identifying a particular UE in the set of UEs. In some implementations, the CN 110 can assign the UE IDs and send each of the UE IDs to a particular UE of the UEs in a NAS procedure (e.g., registration procedure) that the CN 110 performs with the particular UE. For example, the list of UE IDs can include a first UE ID of the UE 102A and a second UE ID of the UE 102B. In some implementations, the UE IDs are S-Temporary Mobile Subscriber Identities (S-TMSIs) (e.g., 5G-S-TMSIs). Before the CN 110 sends the list of UE IDs, the CU 172 can receive the UE ID from the UE 102 or the CN 110 for each of the UEs. For example, the CU 172 can receive a RRC message (e.g., a RRCSetupComplete message) including the UE ID from the UE 102 during a RRC connection establishment procedure. In another example, the CU 172 can receive a CN-to-BS message (e.g., a NGAP message, an INITIAL CONTEXT SETUP REQUEST message or UE INFORMATION TRANSFER message) including the UE ID from the CN 110.

In other implementations, the CN 110 can send 512 to the CU 172 a second CN-to-BS message indicating (only) the UE 102 joins the first MBS session. The second CN-to-BS message can be a UE-associated message for the UE 102. That is, the second CN-to-BS message is specific for the UE 102. In response to receiving the second CN-to-BS message, the CU 172 can send 514 to the DU 174 a UE Context Request message for the UE 102. In some implementations, the CU 172 can include, in the UE Context Request message, the first MBS session ID and/or MRB ID(s) of MRB(s) associated to the first MBS session (ID). In response to the UE Context Request message, the DU 174 sends 516 to the CU 172 a UE Context Response message including configuration parameters for the UE 102A to receive MBS data of the first MBS session. In some implementations, the CU 172 can include the QoS configuration(s) in the UE Context Request message. In such cases, the CU 172 may or may not include the QoS configuration(s) in the CU-to-DU message. (Some of) the configuration parameters may be associated to the MRB(s)/MRB ID(s). In some implementations, the DU 174 generates a DU configuration to include the configuration parameters and includes the DU configuration in the UE Context Response message. In some implementations, the DU configuration can be a CellGroupConfig IE. In other implementations, the DU configuration can be an MBS specific IE. In some implementations, the configuration parameters configure one or more logical channels (LCs). For example, the configuration parameters include one or more logical channel IDs (LCIDs) to configure the one or more logical channel. Each of the LCIDs identifies a particular logical channel of the one or more logical channels.

In some implementations, the second CN-to-BS message and the second BS-to-CN message can be a PDU Session Resource Modify Request message and a PDU Session Resource Modify Response message, respectively. In some implementations, the second CN- to-BS message and the second BS-to-CN message can be UE-associated messages, i.e., the messages are associated to a particular UE (e.g., the UE 102A, 102B or 102C).

Instead of that the CN 110 transmits 504 the first CN-to-BS message to request the CU 172 to configure a common CN-to-BS DL tunnel, the CU 172 in some implementations can transmit 510 the first BS-to-CN message in response to receiving 512 the second CN-to-BS message. Then, the CN 110 can send an CN-to-BS response message to the CU 172 in response to the first BS-to-CN message. In such cases, the CU 172 can transmit 506 the CU-to-DU message to the DU 174 in response to receiving the second CN-to-BS message. In such cases, the first BS-to-CN message and the CN-to-BS response message can be non-UE associated messages, i.e., the messages are not associated to a particular UE.

Instead of that the CU 172 transmits 506 the CU-to-DU message to request to configure a common CU-to-DU DL tunnel, the DU 174 in some implementations can transmit 508 the DU-to-CU message in response to receiving 514 the UE Context Request message in addition to transmitting 516 the UE Context Response message. Then, the CU 172 can send an CU-to-DU response message to the DU 174 in response to the DU-to-CU message. In such cases, the DU-to-CU message and the CU-to-DU response message can be non-UE associated messages, i.e., the messages are not associated to a particular UE.

In cases where the CN 110 grants the additional MBS session(s) for the UE 102 in the additional MBS session join procedure(s), the CN 110 can include the additional MBS session ID(s) and/or QoS configuration(s) for the additional MBS session ID(s) in the first CN-to-BS message or the second CN-to-BS message. In such cases, the CU 172 can include the additional MBS session ID(s) and additional MRB ID(s) in the CU-to-DU message, and the DU 174 include, in the DU-to-CU message, additional DU transport layer configuration(s) to configure additional CU-to-DU DL tunnel(s) for the additional MBS session(s). Alternatively, the CU 172 can perform additional MBS context setup procedure(s) with the DU 174 to obtain the additional DU DL transport layer configuration(s), similar to the events 506 and 508. In some implementations, the CU 172 includes, in the first BS-to-CN message, additional CU DL transport layer configuration(s) for the additional MBS session(s) to configure additional CN-to-BS common DL tunnel(s). Each of the transport layer configuration(s) configures a particular DL tunnel of the common CN-to-BS DL tunnel(s) and can be associated to a particular MBS session of the additional MBS session(s). Alternatively, the CN 110 can perform additional MBS session resource setup procedure(s) with the CU 172 to obtain the additional CU DL transport layer configuration(s) from the CU 172, similar to the MBS session resource setup procedure 586. The transport layer configurations can be different to distinguish between different common DL tunnels. In particular, any pair of the transport layer configurations can have different IP addresses, different DL TEIDs, or different IP addresses as well as different DL TEIDs.

In some implementations, the CN 110 includes the QoS configuration(s) in the second CN-to-BS message. In such cases, the CN 110 may include the QoS configuration(s) in the first CN-to-BS message, or omit the QoS configuration(s). In some implementations, the DU 174 generates the configuration parameters for the UE 102 to receive MBS data of the first MBS session in response receiving the CU-to-DU message or the UE Context Request message. In some implementations, the CU 172 includes the QoS configuration(s) in the UE Context Request message and/or the CU-to-DU message. The DU 174 can determine the content of the configuration parameters in accordance with the QoS configuration(s). When the CU 172 includes the QoS configuration(s) neither in the CU-to-DU message nor the UE Context Request message, the DU 174 can determine values of the configuration parameters in accordance with a predetermined QoS configuration.

In some implementations, the UE Context Request message and the UE Context Response message are a UE Context Setup Request message and a UE Context Setup Response message, respectively. In other implementations, the UE Context Request message and the UE Context Response message are a UE Context Modification Request message and a UE Context Modification Response message, respectively.

After receiving 516 the UE Context Response message, the CU 172 generates an RRC reconfiguration message including the configuration parameters and one or more MRB configurations and transmits 518 the RRC reconfiguration message to the DU 174. In turn, the DU 174 transmits 520 the RRC reconfiguration message to the UE 102. The UE 102 then transmits 522 a RRC reconfiguration complete message to the DU 174, which in turn transmits 523 the RRC reconfiguration complete message to the CU 172. The events 512, 514, 516, 518, 519, 520, 522, and 523 are collectively referred to in FIGS. 5A and 5B as a UE-specific MBS session configuration procedure 590.

In some implementations, the CU 172 generates a PDCP PDU including the RRC reconfiguration message and sends 518 a CU-to-DU message including the PDCP PDU to the DU 174, and the DU 174 retrieves the PDCP PDU from the CU-to-DU message and transmits 520 the PDCP PDU to the UE 102 via the RLC layer 206B, MAC layer 204B and PHY layer 202B. The UE 102 receives 520 the PDCP PDU from the DU 174 via the PHY layer 202B, MAC layer 204B and RLC layer 206B. In some implementations, the UE 102 generates a PDCP PDU including the RRC reconfiguration complete message and transmits 522 the PDCP PDU to the DU 174 via the RLC layer 206B, MAC layer 204B and PHY layer 202B. The DU 174 receives 522 the PDCP PDU from the UE 102 via the PHY layer 202B. MAC layer 204B and RLC layer 206B and sends 523 a DU-to-CU including the PDCP PDU to the CU 172. The CU 172 retrieves the PDCP PDU from the DU-to-CU message and retrieves the RRC reconfiguration complete message from the PDCP PDU.

Before or after receiving 516 the UE Context Response message, the CU 172 can send 519 a second BS-to-CN message to the CN 110 in response to the second CN-to-BS message 512. In some implementations, the CU 172 sends 519 the second BS-to-CN message to the CN 110 before receiving 523 the RRC reconfiguration complete message. In other implementations, the CN 110 sends 519 the second BS-to-CN message to the CN 110 after receiving 523 the RRC reconfiguration complete message. The CU 172 can include the first CN UE interface ID and the first RAN UE interface ID in the second BS-to-CN message. Alternatively, the CU 172 can include the first UE ID in the second BS-to-CN message.

In some implementations, the CU 172 includes the CU DL transport layer configuration(s) in the second BS-to-CN message and/or the additional BS-to-CN message. In other words, the CU 172 can send the same CU DL transport layer configuration(s) in BS-to-CN messages in responses to CN-to-BS messages indicating UEs joining the same MBS session. In such implementations, the CN 110 can blend the MBS resource setup procedure 586 and the second CN-to-BS and BS-to-CN messages into a single procedure.

In cases where the CU 172 performs the MBS resource setup procedure 586 (e.g., events 504, 510) with the CN 110 to establish the common CN-to-BS DL tunnel for the first MBS session, the CU 172 may refrain from including a DL transport layer configuration for the first MBS session in the second BS-to-CN message. In such cases, the CN 110 may refrain from including a UL transport layer configuration for the first MBS session in the second CN-to-BS message. In cases where the DU 174 performs the MBS resource setup procedure (e.g., events 506, 508) with the CU 172 to establish the common CU-to-DU DL tunnel for the first MBS session, the DU 174 may refrain from including a DL transport layer configuration for the first MBS session in the UE Context Response message. In such cases, the CU 172 may refrain from including a UL transport layer configuration for the first MBS session in the UE Context Request message.

After receiving 510 the first BS-to-CN message or 519 the second BS-to-CN message, the CN 110 can send 524 MBS data (e.g., one or multiple MBS data packets) for the first MBS session to the CU 172 via the common CN-to-BS DL tunnel, which in turn sends 526 the MBS data to the DU 174 via the common CU-to-DU tunnel. The DU 174 transmits (e.g., multicast or unicast) 528 the MBS data via the one or more logical channels to the UE 102. The UE 102 receives 528 the MBS data via the one or more logical channels. For example, the CU 172 receives 524 an MBS data packet, generates a PDCP PDU including the MBS data packet, and transmits 528 the PDCP PDU to the DU 174. In turn, the DU 174 generates a MAC PDU including the logical channel ID and the PDCP PDU, and transmits 528 the MAC PDU to the UE 102 via multicast or unicast. The UE 102 receives 528 the MAC PDU via multicast or unicast, retrieves the PDCP PDU and the logical channel ID from the MAC PDU, identifies the PDCP PDU associated with the MRB in accordance with the logical channel ID, and retrieves the MBS data packet from the PDCP PDU in accordance with a PDCP configuration within the MRB configuration.

In some implementations, the configuration parameters can include one or more MRB configurations configuring one or more MRBs associated with the first MBS session. The configuration parameters can also include one or more RLC bearer configurations, each associated with a particular MRB. Each of the MRB configuration(s) can include an MRB ID, a PDCP configuration, the first MBS session ID, a PDCP reestablishment indication (e.g., reestablishPDCP), and/or a PDCP recovery indication (e.g., recoveryPDCP). In some implementations, the PDCP configuration can be a PDCP-Config IE for DRB. In some implementations, the RLC bearer configuration can be an RLC-BearerConfig IE. In some implementations, the RLC bearer configuration may include a logical channel (LC) ID configuring a logical channel. In some implementations, the logical channel can be a multicast traffic channel (MTCH). In other implementations, the logical channel can be a dedicated traffic channel (DTCH). In some implementations, the configuration parameters may include logical channel configuration (e.g., LogicalChannelConfig IE) configuring the logical channel. In some implementations, the RLC bearer configuration may include the MRB ID.

In some implementations, the CU 172 can configure the MRB as a DL-only RB in the MRB configuration. For example, the CU 172 can refrain from including UL configuration parameters in the PDCP configuration within the MRB configuration to configure the MRB as a DL-only RB. The CU 172 can include only DL configuration parameters in the MRB configuration, e.g., as described above. In such cases, the CU 172 configures the UE 102 to not transmit UL PDCP data PDU via the MRB to the DU 174 and/or the CU 172 by excluding the UL configuration parameters for the MRB in the PDCP configuration in the MRB configuration. In another example, the DU 174 refrains from including UL configuration parameters in the RLC bearer configuration. In such cases, the DU 174 configures the UE 102 not to transmit the control PDU(s) via the logical channel to the base station 104 by excluding the UL configuration parameters from the RLC bearer configuration.

In cases where the DU 174 includes UL configuration parameter(s) in the RLC bearer configuration, the UE 102 may transmit control PDU(s) (e.g., PDCP Control PDU(s) and/or RLC Control PDU(s)) via the logical channel to the DU 174 using the UL configuration parameter(s). If the control PDU is a PDCP control PDU, the DU 174 can send the PDCP control PDU to the CU 172. For example, the CU 172 may configure the UE to receive MBS data with a (de) compression protocol (e.g., robust header compression (ROHC) protocol). In this case, when the CU 172 receives 524 an MBS data packet from the CN 110, the CU 172 compresses the MBS data packet with the compression protocol to obtain compressed MBS data packet(s) and transmits 526 a PDCP PDU including the compressed MBS data packet to the DU 174 via the common CU-to-DU DL tunnel. In turn, the DU 174 transmits (e.g., multicast or unicast) 528 the PDCP PDU to the UE 102 via the logical channel. When the UE 102 receives the PDCP PDU via the logical channel, the UE 102 retrieves the compressed MBS data packet from the PDCP PDU. The UE 102 decompresses the compressed MBS data packet(s) with the (de) compression protocol to obtain the original MBS data packet. In such cases, the UE 102 may transmit a PDCP Control PDU including, a header compression protocol feedback (e.g., interspersed ROHC feedback) for operation of the header (de) compression protocol, via the logical channel to the DU 174. In turn, the DU 174 sends the PDCP Control PDU to the CU 172 via a UE-specific UL tunnel, i.e., the UL tunnel is specific for the UE 102 (e.g., the UE 102A). In some implementations, the CU 172 can include, in the UE Context Request message, a CU UL transport layer configuration configuring the UE-specific UL tunnel. The CU UL transport layer configuration includes a CU transport layer address (e.g., an Internet Protocol (IP) address) and a CU UL TEID to identify the UE-specific UL tunnel.

In some implementations, the MRB configuration can be an MRB-ToAddMod IE including an MRB ID (e.g., mrb-Identity or MRB-Identity). An MRB ID identifies a particular MRB of the MRB(s). The base station 104 sets the MRB IDs to different values. In cases where the CU 172 has configured DRB(s) to the UE 102 for unicast data communication, the CU 172 in some implementations can set one or more of the MRB ID(s) to values different from DRB ID(s) of the DRB(s). In such cases, the UE 102 and the CU 172 can distinguish whether an RB is a MRB or DRB in accordance an RB ID of the RB. In other implementations, the CU 172 can set one or more of the MRB ID(s) to values which can be the same as the DRB ID(s). In such cases, the UE 102 and the CU 172 can distinguish whether an RB is a MRB or DRB in accordance an RB ID of the RB and a RRC IE configuring the RB. For example, a DRB configuration configuring a DRB is a DRB-ToAddMod IE including a DRB identity (e.g., drb-Identity or DRB-Identity) and a PDCP configuration. Thus, the UE 102 can determine an RB is an DRB if the UE 102 receives a DRB-ToAddMod IE configuring the RB, and determine an RB is a MRB if the UE 102 receives an MRB-ToAddMod IE configuring the RB. Similarly, the CU 172 can determine an RB is an DRB if the CU 172 transmits a DRB-ToAddMod IE configuring the RB to the UE 102, and determine an RB is a MRB if the CU 172 transmits an MRB-ToAddMod IE configuring the RB to the UE 102.

In some implementations, the configuration parameters for receiving MBS data of the first MBS session include one or more logical channel (LC) IDs to configure one or more logical channels. In some implementations, the logical channel(s) can be dedicated traffic channel(s) (DTCH(s)). In other implementations, the logical channel(s) can be multicast traffic channel(s) (MTCH(s)). In some implementations, the configuration parameters may or may not include a group radio network temporary identifier (G-RNTI). The RRC reconfiguration messages for UEs joining the first MBS session, include the same configuration parameters for receiving MBS data of the first MBS session. In some implementations, the RRC reconfiguration messages for the UEs may include the same or different configuration parameters for receiving non-MBS data.

In some implementations, the CU 172 can include the MBS session join response message in the RRC reconfiguration message. The UE 102 can include the MBS session join complete message in the RRC reconfiguration complete message. Alternatively, the UE 102 can send a UL RRC message including the MBS session join complete message to the CU 172 via the DU 174. The UL RRC message can be a ULInformationTransfer message or any suitable RRC message that can include a UL NAS PDU. The CU 172 can include the MBS session join complete message in the second BS-to-CN message. Alternatively, the CU 172 can send to the CN 110 a BS-to-CN message (e.g., an UPLINK NAS TRANSPORT message) including the MBS session join complete message.

In other implementations, the CU 172 transmits a DL RRC message that includes the MBS session join response message to the UE 102. The DL RRC message can be a DLInformation Transfer message, another RRC reconfiguration message, or any suitable RRC message that can include a DL NAS PDU. The UE 102 can send a UL RRC message including the MBS session join complete message to the CU 172 via the DU 174. The UL

RRC message can be a ULInformationTransfer message, another RRC reconfiguration complete message or any suitable RRC message that can include a UL NAS PDU.

With continued reference to FIG. 5A, the UE 103 can perform 530 an MBS session join procedure similar to the procedure 502 discussed above. The UE 103 can perform a PDU session establishment procedure with the CN 110 via the base station 104 as described above. The UE 103 can communicate a PDU session ID with the CN 110 in the PDU session establishment procedure. The UE 103 can join a different MBS session from the UE 102 by sending an MBS session join request and specifying a different MBS session ID (e.g., a second MBS session ID).

The CU 172 includes additional transport layer configuration(s) for the additional MBS session(s) to configure additional common DL tunnel(s) in BS-to-CN message(s) in the MBS resource setup and UE-specific MBS session configuration procedure(s), similar to the first or second BS-to-CN message. Each of the transport layer configuration(s) configures a particular common DL tunnel of the common DL tunnel(s) and can be associated to a particular MBS session of the additional MBS session(s). The transport layer configurations can be different to distinguish between different common DL tunnels. In particular, any pair of the transport layer configurations can have different IP addresses, different DL TEIDs, or different IP addresses as well as different DL TEIDs.

The CU 172 and the CN 110 then perform 587 an MBS session resource setup procedure for the second MBS session to establish a second common CN-to-BS DL tunnel and a second common CU-to-DU DL tunnel, similar to the MBS session resource setup procedure 586 for the first MBS session discussed above. The UE 103, the CU 172, and the CN 110 perform 589 a UE-specific MBS session configuration procedure for the second MBS session, similar to the UE-specific MBS session configuration procedure 590 for the first MBS session discussed above.

In the UE-specific MBS session configuration procedure 590 for the second MBS session, the RRC reconfiguration message can include different LCID (value), MRB configuration, and RLC bearer configuration as the event 520. The RRC reconfiguration message can have a different G-RNTI, LCID and/or RLC bearer configuration, for example.

The CN 110 can then send 532, 538 MBS data for the first MBS session and MBS data for the second MBS session to the CU 172 via their respective common CN-to-BS DL tunnels. Then the CU 172 sends 534, 540 the MBS data for the first MBS session and the MBS data for the second MBS session to the DU 174 via their respective common CU-to-DU DL tunnels. The DU 174 transmits (e.g., multicast or unicast) 536 the MBS data for the second MBS session via one or more logical channels and/or MRB(s) to the UE 103 and transmits (e.g., multicast or unicast) 542 the MBS data for the first MBS session via one or more logical channels and/or MRB(s) to the UE 102. The UE 102 receives 542 the MBS data for the first MBS session via the one or more logical channels, and the UE 103 receives 536 the MBS data for the second MBS session via the one or more logical channels which may different from the logical channels for the first MBS session.

FIG. 5B illustrates an example scenario 500B similar to the scenario illustrated in FIG. 5A. In the example scenario 500B, the UE 103 joins both a second MBS session (as in the example scenario 500A) and a first MBS session during the same time period. More specifically, the UE 103 can perform 530 an MBS session join procedure for the second MBS session, and can perform 531 an MBS session join procedure for the first MBS session. The base station 104 and the CN 110 then perform 587 an MBS session resource setup procedure for the second MBS session. The UE 103, the base station 104, and the CN 110 perform 589 a UE-specific MBS session configuration procedure for the second MBS session. Furthermore, the UE 103, the base station 104, and the CN perform a UE-specific MBS session configuration procedure for the first MBS session.

The UE 103 can join the same MBS session as the UE 102 by specifying the same MBS session ID in the MBS session join request (e.g., the first MBS session ID). In this example scenario, the UE 103 joins the first MBS session after the base station 104 has started transmitting 528 MBS data packets for the first MBS session to the UE 102. The CN 110 transmits, to the CU 172, a CN-to-BS message including the MBS session ID and/or the PDU session ID in order to indicate that the UE 103 should start receiving MBS data for the first MBS session corresponding to the first MBS session ID.

The CU 172 or CN 110 determines that a DL tunnel for the first MBS session already exists, and that there is no need to perform the procedure 586. Optionally, however, the CU 172 sends a CU-to-DU message to the DU 174 to request a set-up for an MBS context and/or a common DL tunnel for the first MBS session, and the DU 174 responds with a DU configuration. The CU 172 transmits an RRC reconfiguration message to the UE 103 to configure the UE 103 to receive the MBS traffic for the first MBS session. The RRC reconfiguration message can include the same LCID (value), MRB configuration, and RLC bearer configuration as for the UE 102, when the UEs 102 and 103 operate in the same cell. When the UEs 102A and 102B operate in different cells, the RRC reconfiguration message can have a different, G-RNTI, LCID and/or RLC bearer configuration, for example. The RRC reconfiguration message can include the same MRB configuration as for the UE 102, when the UEs 102 and 103 operate in different cells. As illustrated in FIG. 3, the CU 172 can map data packets arriving via the common CN-to-BS DL tunnel to one or more MRBs, each corresponding to a common CU-to-DU DL tunnel and/or a respective logical channel. Furthermore, the RRC reconfiguration message can include the same LCID (value), MRB configuration, and RLC bearer configuration for the first MBS session for UE 103 as the LCID (value), MRB configuration, and RLC bearer configuration for the second MBS session for the UE 103. Accordingly, the UE 103 may receive MBS data for the first and second MBS sessions via the same logical channel(s) and/or MRB(s).

In any event, the CN 110 can then send 532, 538 MBS data for the first MBS session and MBS data for the second MBS session to the CU 172. Then the CU 172 sends 534, 540 the MBS data for the first MBS session and the MBS data for the second MBS session to the DU 174. The DU 174 transmits (e.g., multicast or unicast) 536 the MBS data for the second MBS session via one or more logical channels and/or MRB(s) to the UE 103, and transmits (e.g., multicast or unicast) 546 the MBS data for the first MBS session via one or more logical channels and/or MRB(s) to the UE 103. The UE 103 receives 536, 546 the MBS data for the first MBS session and the MBS data for the second MBS session during the same time period, such that the UE 103 can receive two sets of MBS data for different MBS sessions at once. Additionally, the DU 174 transmits (e.g., multicast or unicast) 542 the MBS data for the first MBS session via one or more logical channels and/or MRB(s) to the UE 102. In some implementations, the DU 174 transmits 542, 546 the MBS data for the first MBS session to the UEs 102, 103 via multicast. In other implementations, the DU 174 transmits 542, 546 the MBS data for the first MBS session to the UEs 102, 103 separately via unicast.

In some implementations, the CU 172 transmits 544 two instances of the MBS data for the first MBS session to the DU 174. The DU then transmits 542 the first instance of the MBS data for the first MBS session to the UE 102 and transmits 546 the second instance of the MBS data for the first MBS session to the UE 103. In other implementations, the DU 174 receives a single instance of the MBS data for the first MBS session from the CU 172 and transmits the MBS data for the first MBS sessions to each of the UEs that joined the first MBS session.

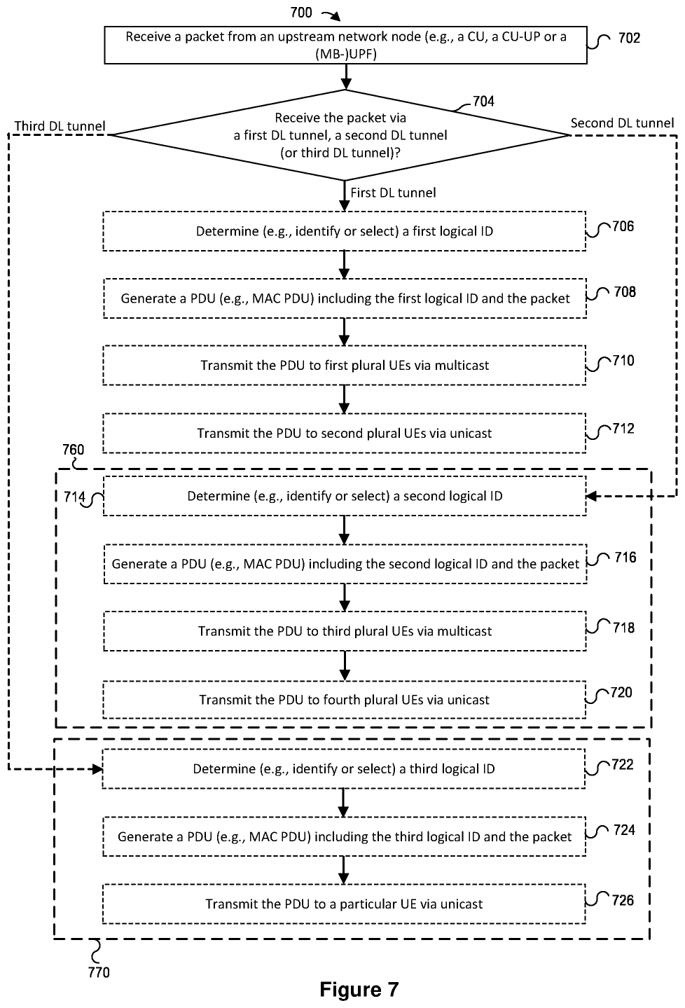

Next, several example scenarios which devices illustrated in FIGS. 1A and 1B can implement are discussed with reference to FIGS. 6-15. Each of these methods can be implemented as a set of instructions stored on a non-transitory computer-readable medium and executable by one or more processors and/or can be implemented by processing hardware.

Referring first to FIG. 6, a base station such as the base station 104 or a DU within the base station 104 can implement a method 600 to identify UEs to transmit an MBS data packet via multicast and/or identify UE(s) to transmit the MBS data packet via unicast. The method 600 begins at block 602, where the base station or DU receives a data packet from an upstream network node (e.g., a CU, a CU-UP, an (MB-) UPF, etc.) via a certain DL tunnel (see e.g., events 524, 526, 532, 534, 538, 540, 544). The base station or DU can determine to which tunnel a data packet corresponds based on the IP address and the TEID or other suitable transport-layer information included in the header of the packet. The data packet can be an IP packet, an Ethernet packet or a UP packet. In such cases, the base station or the DU receives the data packet from the UPF (e.g., UPF 162 or MB-UPF 162). In some implementations, the data packet is associated with an MBS session. Also in some implementations, the packet can be a PDCP PDU, and the DU can receive the PDCP PDU from the CU. In cases where the PDCP PDU includes an IP packet, an Ethernet packet, MBS data packet, or a UP packet, the DU can receive the PDCP PDU from the CU-UP (e.g., CU-UP 172B).

At block 604, the base station or DU identifies the DL tunnel from which the data packet was received. For example, the base station or DU identifies the DL tunnel as a first DL tunnel, a second DL tunnel, or a third DL tunnel. Then the base station or DU identifies UEs to transmit the data packet via multicast and/or UE(s) to transmit the data packet via unicast based on the DL tunnel via which the data packet was received. For example, the base station or DU can maintain a table or mapping indicating for each active DL tunnel, a set of UEs for receiving the MBS data packet via multicast (e.g., as indicated by a G-RNTI), a set of UEs for receiving the MBS data packet via unicast (e.g., as indicated by C-RNTIs), an individual legacy UE for receiving the MBS data packet via unicast (e.g., as indicated by a C-RNTI), logical channel IDs corresponding to the DL tunnel, an MRB for the DL tunnel, a DRB for the DL tunnel, etc.

In response to determining that the DL tunnel is a first DL tunnel, the base station or DU transmits the data packet to a first set of UEs via an MBS multicast data transmission (block 606) (see e.g., events 528, 536, 542, 546), and transmits the data packet to a second set of UEs via MBS unicast data transmissions (block 608) (see e.g., events 528, 536, 542, 546).

In response to determining that the DL tunnel is a second DL tunnel, the base station or DU transmits the data packet to a third set of UEs via an MBS multicast data transmission (block 610) (see e.g., events 528, 536, 542, 546), and transmits the data packet to a fourth set of UEs via MBS unicast data transmissions (block 612) (see e.g., events 528, 536, 542, 546). In some implementations, the first set of UEs and the third set of UEs may include identical UEs and/or different UEs. Also in some implementations, the second set of UEs and the fourth set of UEs may include identical UEs and/or different UEs.

In response to determining that the DL tunnel is a third DL tunnel, the base station or DU transmits the data packet to a particular legacy UE via a non-MBS unicast data transmission (block 614).

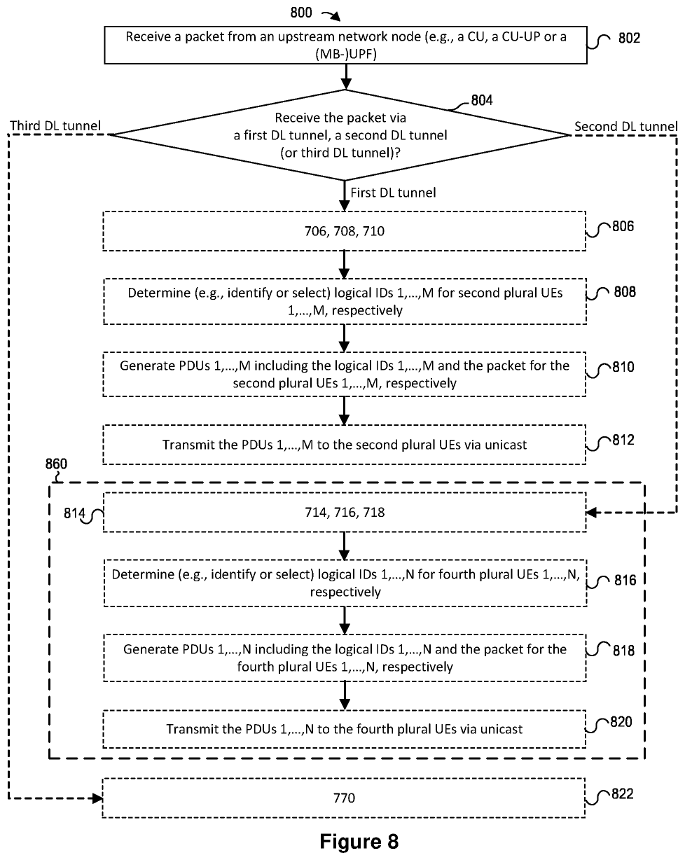

FIG. 7 illustrates an example method 700 similar to method 600 except that in the method 700, the base station or DU identifies a logical channel to use to transmit the MBS data packet to the UE(s) based on the tunnel via which the data packet was received.

In response to determining that the DL tunnel is a first DL tunnel, the base station or DU determines (e.g., identify or select) a first logical channel ID (block 706). The base station or DU then generates a PDU (e.g., a MAC PDU) that includes the first logical channel ID and the data packet (block 708). Then the base station or DU transmits the PDU to a first set of UEs via an MBS multicast data transmission (block 710) (see e.g., events 528, 536, 542, 546), and transmits the PDU to a second set of UEs via MBS unicast data transmissions (block 712) (see e.g., events 528, 536, 542, 546).

In response to determining that the DL tunnel is a second DL tunnel, the base station or DU determines (e.g., identifies or selects) a second logical channel ID (block 714). The base station or DU then generates a PDU (e.g., a MAC PDU) that includes the second logical channel ID and the data packet (block 716). Then the base station or DU transmits the PDU to a third set of UEs via an MBS multicast data transmission (block 718) (see e.g., events 528, 536, 542, 546), and transmits the PDU to a fourth set of UEs via MBS unicast data transmissions (block 720) (see e.g., events 528, 536, 542, 546). Blocks 714, 716, 718, and 720 are collectively referred to in FIG. 7 as block 760.

In response to determining that the DL tunnel is a third DL tunnel, the base station or DU determines (e.g., identifies or selects) a third logical channel ID (block 722). The base station or DU then generates a PDU (e.g., a MAC PDU) that includes the third logical channel ID and the data packet (block 724). Then the base station or DU transmits the data packet to a particular legacy UE via a non-MBS unicast data transmission (block 726). Blocks 722, 724, and 726 are collectively referred to in FIG. 7 as block 770.

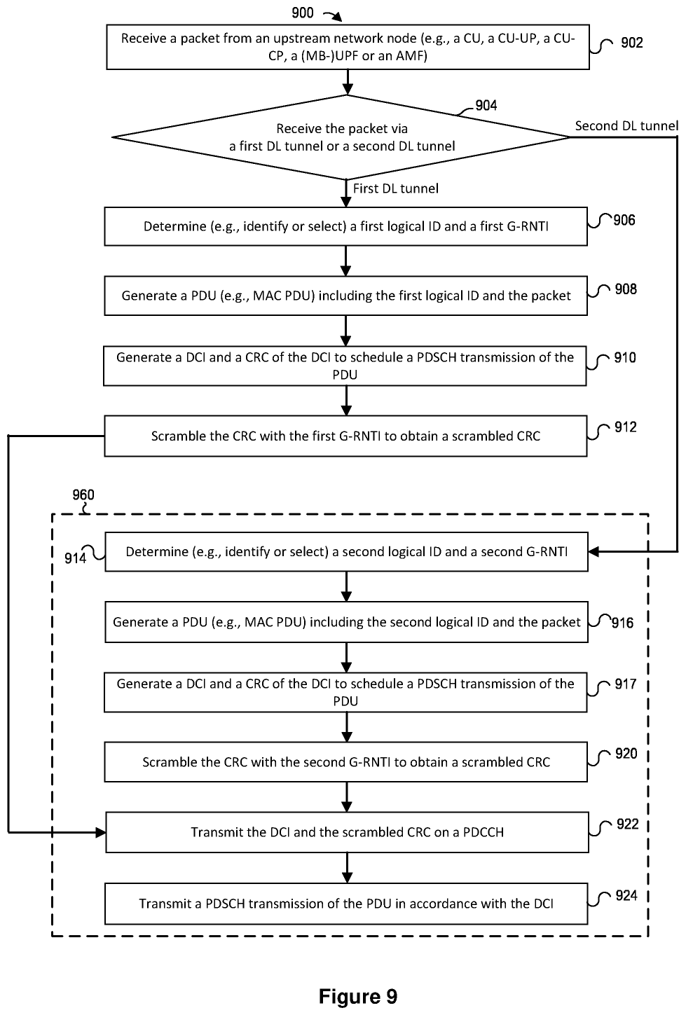

FIG. 8 illustrates an example method 800 similar to method 700 except that in the method 800, the base station or DU identifies a set of logical channels to use to transmit the MBS data packet to the respective UEs via unicast.

In response to determining that the DL tunnel is a first DL tunnel, the base station or DU performs some of the same steps as in the method 700 (blocks 706, 708, 710) to transmit the MBS data packet to the first set of UEs via multicast. To transmit the MBS data packet to the second set of UEs via unicast, the base station or DU determines (e.g., identifies or selects) a set of M logical channel IDs corresponding to the second set of M UEs (block 808). The base station or DU then generates M PDUs each including one of the M logical channel IDs and the data packet for the respective second set of M UEs (block 810) (see e.g., events 528, 536, 542, 546). Then the base station or DU transmits the M PDUs to the respective second set of M UEs via M MBS unicast data transmissions (block 812) (see e.g., events 528, 536, 542, 546).

In response to determining that the DL tunnel is a second DL tunnel, the base station or DU performs some of the same steps as in the method 700 (blocks 714, 716, 718) to transmit the MBS data packet to the third set of UEs via multicast. To transmit the MBS data packet to the fourth set of UEs via unicast, the base station or DU determines (e.g., identifies or selects) a set of N logical channel IDs corresponding to the fourth set of NUEs (block 816). The base station or DU then generates N PDUs each including one of the N logical channel IDs and the data packet for the respective fourth set of N UEs (block 818) (see e.g., events 528, 536, 542, 546). Then the base station or DU transmits the N PDUs to the respective fourth set of N UEs via N MBS unicast data transmissions (block 820) (sec e.g., events 528, 536, 542, 546). Blocks 814, 816, 818, and 820 are collectively referred to in FIG. 8 as block 860.

FIG. 9 illustrates an example method 900 similar to method 700 except that in the method 900, the base station or DU identifies a G-RNTI for transmitting the MBS data packet to UEs corresponding to the G-RNTI via multicast, where the G-RNTI and corresponding UEs are identified based on the tunnel via which the data packet was received.

In response to determining that the DL tunnel is a first DL tunnel, the base station or DU determines (e.g., identifies or selects) a first logical channel ID and a first G-RNTI corresponding to the first set of UEs from the method 700 (block 906). The base station or DU then generates a PDU (e.g., a MAC PDU) that includes the first logical channel ID and the data packet (block 908) (see e.g., events 528, 536, 542, 546). The base station or DU also generates a DCI and a CRC of the DCI to schedule a physical downlink shared channel (PDSCH) transmission of the PDU (block 910) (see e.g., events 528, 536, 542, 546). Then the base station or DU scrambles the CRC with the first G-RNTI to obtain a scrambled CRC (block 912). The base station or DU transmits the DCI and the scrambled CRC on a physical downlink control channel (PDCCH) (block 922) (see e.g., events 528, 536, 542, 546), and transmits the PDSCH transmission of the PDU via multicast in accordance with the DCI (block 924) (see e.g., events 528, 536, 542, 546). In this manner, the first set of UEs corresponding to the first G-RNTI receive the MBS data packet.

In response to determining that the DL tunnel is a second DL tunnel, the base station or DU determines (e.g., identifies or selects) a second logical channel ID and a second G-RNTI corresponding to the third set of UEs from the method 700 (block 914). The base station or DU then generates a PDU (e.g., a MAC PDU) that includes the second logical channel ID and the data packet (block 916) (see e.g., events 528, 536, 542, 546). The base station or DU also generates a DCI and a CRC of the DCI to schedule a PDSCH transmission of the PDU (block 917) (see e.g., events 528, 536, 542, 546). Then the base station or DU scrambles the CRC with the second G-RNTI to obtain a scrambled CRC (block 920) (see e.g., events 528, 536, 542, 546). The base station or DU transmits the DCI and the scrambled CRC on a PDCCH (block 922), and transmits the PDSCH transmission of the PDU via multicast in accordance with the DCI (block 924) (see e.g., events 528, 536, 542, 546). In this manner, the third set of UEs corresponding to the second G-RNTI receive the MBS data packet. Blocks 914, 916, 917, 920, 922, and 924 are collectively referred to in FIG. 9 as block 960.

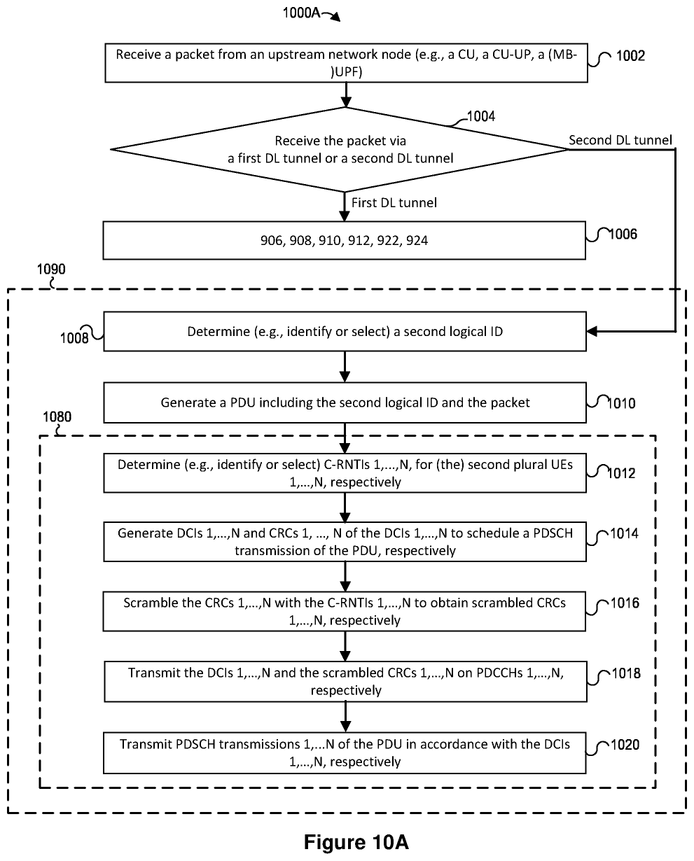

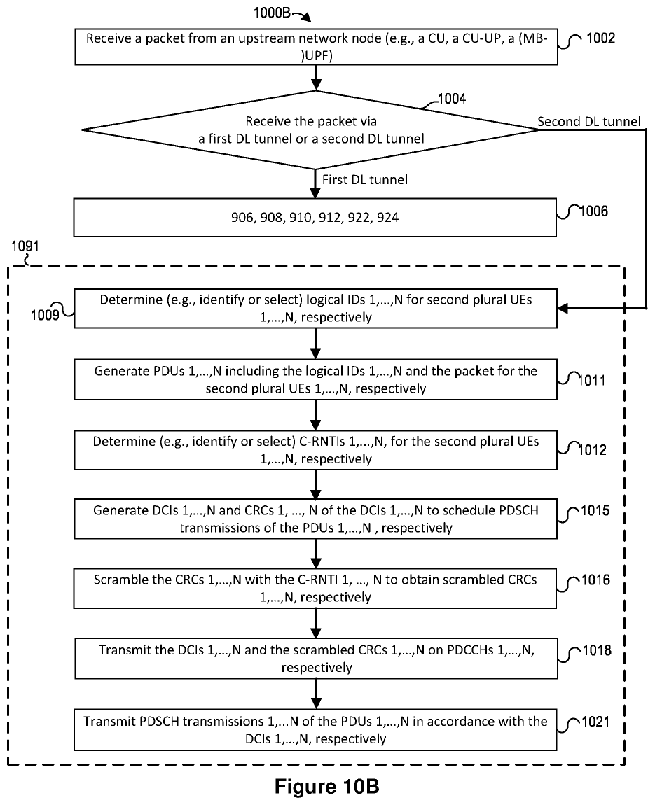

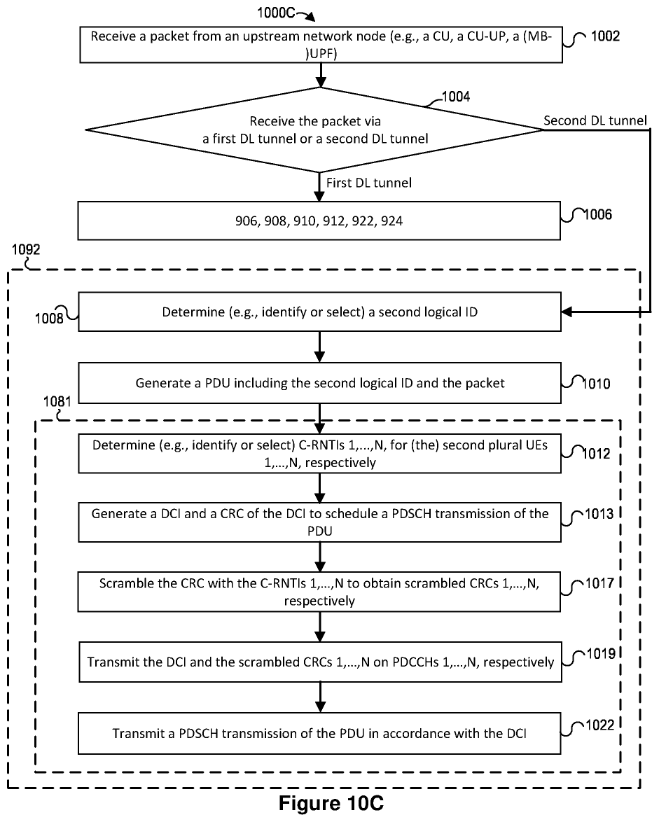

FIGS. 10A-10C illustrate example methods 1000A, 1000B, 1000C similar to method 900 except that in the methods 1000A, 1000B, and 1000C, when the tunnel via which the data packet was received is a second DL tunnel, the base station or DU transmits the MBS data packet via unicast.

In the method 1000A, in response to determining that the DL tunnel is a first DL tunnel, the base station or DU performs some of the same steps as in the method 900 (blocks 906, 908, 910, 912, 922, and 924) to transmit the MBS data packet to the first set of UEs via multicast.

In response to determining that the DL tunnel is a second DL tunnel, the base station or DU determines (e.g., identifies or selects) a second logical channel ID (block 1008). The base station or DU then generates a PDU (e.g., a MAC PDU) that includes the second logical channel ID and the data packet (block 1010). The base station or DU also determines (e.g., identifies or selects) N C-RNTIs for identifying a second set of N UEs, respectively (e.g., the fourth set of UEs in method 700 for receiving the PDU from the second DL tunnel via unicast) (block 1012). The base station or DU then generates N DCIs and N CRCs for the N DCIs to schedule N PDSCH transmissions of the PDU (block 1014) (see e.g., events 528, 536, 542, 546). Then the base station or DU scrambles each of the N CRCs with a respective C-RNTI to obtain N scrambled CRCs (block 1016) (see e.g., events 528, 536, 542, 546). The base station or DU transmits the N DCIs and the N scrambled CRCs on N PDCCHs, respectively (block 1018) (see e.g., events 528, 536, 542, 546). Then the base station or DU transmits N PDSCH transmission of the PDU via unicast in accordance with the N DCIs, respectively (block 1020) (see e.g., events 528, 536, 542, 546). In this manner, the second set of N UEs corresponding to the N C-RNTIs receive the MBS data packet. Blocks 1012, 1014, 1016, 1018, and 1020 are collectively referred to in FIG. 10A as block 1080. Blocks 1008, 1010, and 1080 are collectively referred to in FIG. 10A as block 1090.

FIG. 10B illustrates an example method 1000B similar to method 1000A except that in the method 1000B, the base station or DU identifies a set of N logical channels and generates a set of N PDUs to use to transmit the MBS data packet to the respective second set of N UEs via unicast.

In response to determining that the DL tunnel is a second DL tunnel, the base station or DU determines (e.g., identifies or selects) a set of N logical channel IDs corresponding to the second set of N UEs (e.g., the fourth set of UEs in method 700 for receiving the PDU from the second DL tunnel via unicast) (block 1009). The base station or DU then generates N PDUs each including one of the N logical channel IDs and the data packet for the respective second set of N UEs (block 1011) (see e.g., events 528, 536, 542, 546). The base station or DU also determines (e.g., identifies or selects) N C-RNTIs for identifying the second set of N UEs, respectively (block 1012). The base station or DU then generates N DCIs and N CRCs for the N DCIs to schedule N PDSCH transmissions of the N PDUs, respectively (block 1015) (see e.g., events 528, 536, 542, 546). Then the base station or DU scrambles each of the N CRCs with a respective C-RNTI to obtain N scrambled CRCs (block 1016) (see e.g., events 528, 536, 542, 546). The base station or DU transmits the N DCIs and the N scrambled CRC on N PDCCHs, respectively (block 1018) (see e.g., events 528, 536, 542, 546). Then the base station or DU transmits N PDSCH transmissions of the N PDUs via unicast in accordance with the N DCIs, respectively (block 1021) (see e.g., events 528, 536, 542, 546). In this manner, the second set of N UEs corresponding to the N C-RNTIs receive the MBS data packet. Blocks 1009, 1011, 1012, 1015, 1016, 1018, and 1021 are collectively referred to in FIG. 10B as block 1091.

FIG. 10C illustrates an example method 1000C similar to method 1000A except that in the method 1000C, the base station or DU generates the same DCI and scrambles the same CRC with the N C-RNTIs for identifying the second set of N UEs for each of the N PDCCH transmissions.

In response to determining that the DL tunnel is a second DL tunnel, the base station or DU determines (e.g., identifies or selects) a second logical channel ID (block 1008). The base station or DU then generates a PDU (e.g., a MAC PDU) that includes the second logical channel ID and the data packet (block 1010) (see e.g., events 528, 536, 542, 546). The base station or DU also determines (e.g., identifies or selects) N C-RNTIs for identifying a second set of N UEs, respectively (e.g., the fourth set of UEs in method 700 for receiving the PDU from the second DL tunnel via unicast) (block 1012). The base station or DU then generates a single DCI and a single CRC for the DCI to schedule a PDSCH transmission of the PDU (block 1013) (see e.g., events 528, 536, 542, 546). Then the base station or DU scrambles the CRC with each of the N C-RNTIs to obtain N scrambled CRCs (block 1017) (see e.g., events 528, 536, 542, 546). The base station or DU transmits the DCI and the N scrambled CRCs on N PDCCHs, respectively (block 1019) (see e.g., events 528, 536, 542, 546). Then the base station or DU transmits a PDSCH transmission of the PDU via unicast in accordance with the DCI (block 1022) (see e.g., events 528, 536, 542, 546). In this manner, the second set of N UEs corresponding to the N C-RNTIs receive the MBS data packet. Blocks 1012, 1013, 1017, 1019, and 1022 are collectively referred to in FIG. 10C as block 1081. Blocks 1008, 1010, and 1081 are collectively referred to in FIG. 10C as block 1092.

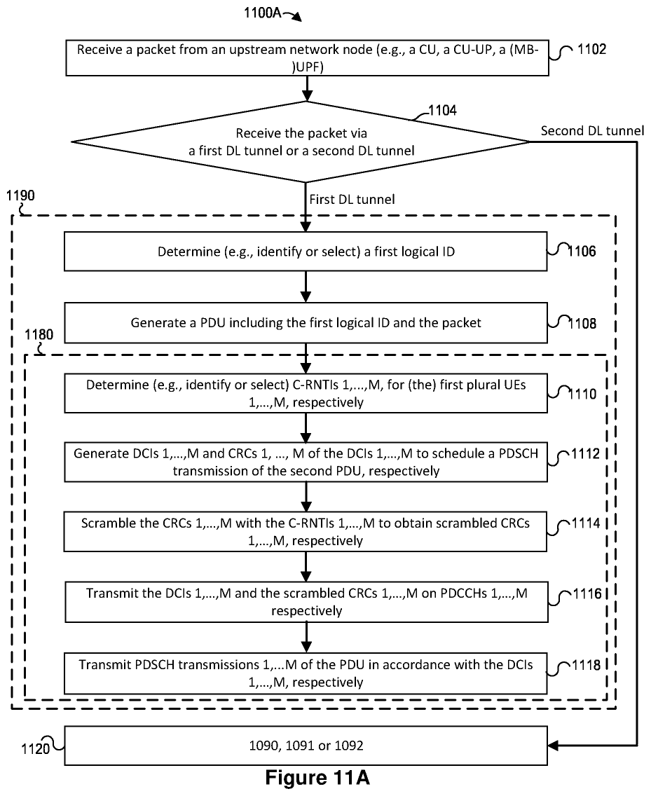

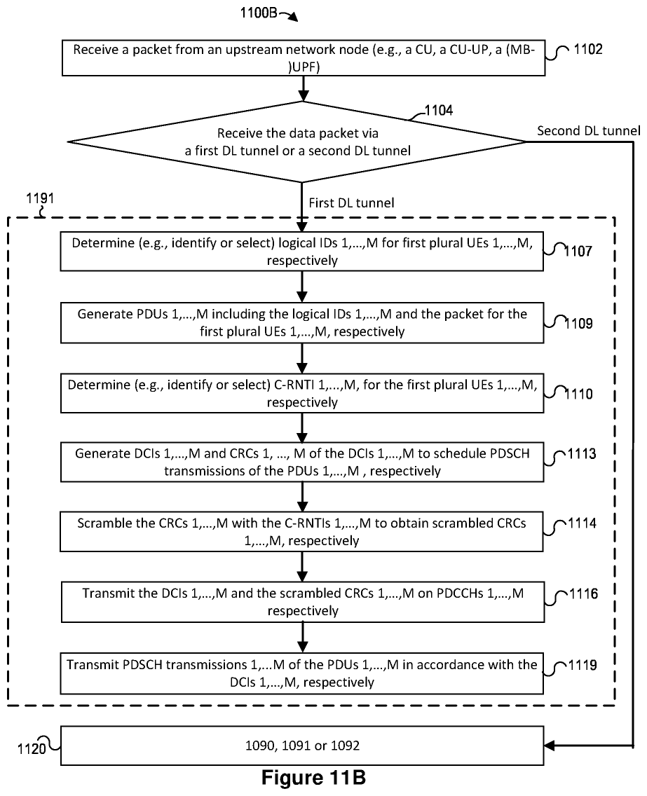

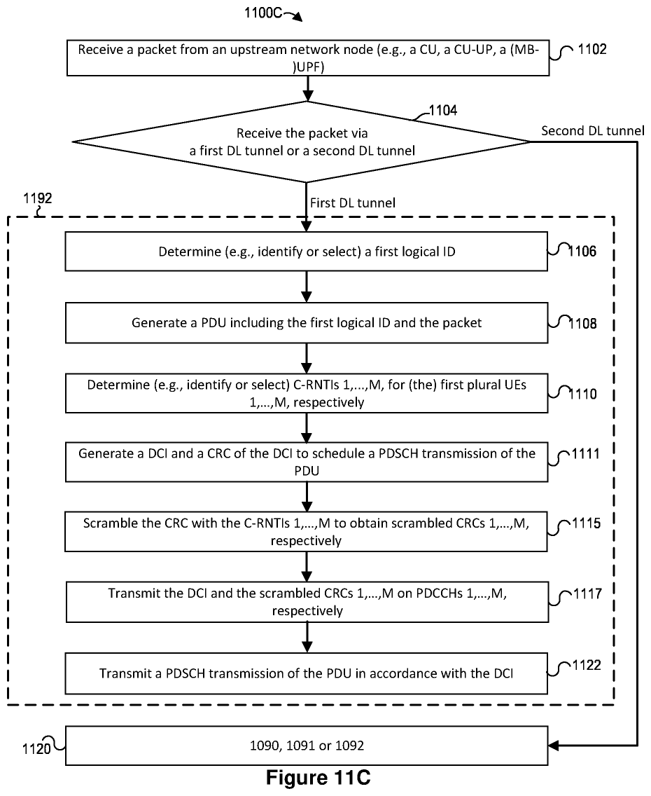

FIGS. 11A-11C illustrate example methods 1100A, 1100B, 1100C similar to methods 1000A, 1000B, 1000C, respectively, except that in the methods 1100A, 1100B, and 1100C, when the tunnel via which the data packet was received is a first DL tunnel, the base station or DU also transmits the MBS data packet via unicast. In the example methods 1100A, 1100B, 1100C, the MBS data packet is transmitted via unicast for both the first DL tunnel and the second DL tunnel.

FIG. 11A illustrates an example method 1100A that includes similar steps for transmitting the data packet received via the first DL tunnel as in the method 1000A when the data packet was received via the second DL tunnel. More specifically, in response to determining that the DL tunnel is a first DL tunnel, the base station or DU determines (e.g., identifies or selects) a first logical channel ID (block 1106). The base station or DU then generates a PDU (e.g., a MAC PDU) that includes the first logical channel ID and the data packet (block 1108) (see e.g., events 528, 536, 542, 546). The base station or DU also determines (e.g., identifies or selects) M C-RNTIs for identifying a first set of M UEs, respectively (e.g., the second set of UEs in method 700 for receiving the PDU from the first DL tunnel via unicast) (block 1110) (see e.g., events 528, 536, 542, 546). The base station or DU then generates M DCIs and M CRCs for the M DCIs to schedule M PDSCH transmissions of the PDU, respectively (block 1112) (see e.g., events 528, 536, 542, 546). Then the base station or DU scrambles each of the M CRCs with a respective C-RNTI to obtain M scrambled CRCs (block 1114) (see e.g., events 528, 536, 542, 546). The base station or DU transmits the M DCIs and the M scrambled CRCs on M PDCCHs, respectively (block 1116). Then the base station or DU transmits M PDSCH transmission of the PDU via unicast in accordance with the M DCIs, respectively (block 1118) (see e.g., events 528, 536, 542, 546). In this manner, the first set of M UEs corresponding to the M C-RNTIs receive the MBS data packet. Blocks 1110, 1112, 1114, 1116, and 1118 are collectively referred to in FIG. 11A as block 1180. Blocks 1106, 1108, and 1180 are collectively referred to in FIG. 11A as block 1190.

FIG. 11B illustrates an example method 1100B that includes similar steps for transmitting the data packet received via the first DL tunnel as in the method 1000B when the data packet was received via the second DL tunnel. More specifically, in response to determining that the DL tunnel is a first DL tunnel, the base station or DU determines (e.g., identifies or selects) a set of M logical channel IDs corresponding to the first set of M UEs (e.g., the second set of UEs in method 700 for receiving the PDU from the first DL tunnel via unicast) (block 1107). The base station or DU then generates M PDUs each including one of the M logical channel IDs and the data packet for the respective first set of M UEs (block 1109) (see e.g., events 528, 536, 542, 546). The base station or DU also determines (e.g., identifies or selects) M C-RNTIs for identifying the first set of M UEs, respectively (block 1110). The base station or DU then generates M DCIs and M CRCs for the M DCIs to schedule M PDSCH transmissions of the M PDUs, respectively (block 1113) (see e.g., events 528, 536, 542, 546). Then the base station or DU scrambles each of the M CRCs with a respective C-RNTI to obtain M scrambled CRCs (block 1114) (see e.g., events 528, 536, 542, 546). The base station or DU transmits the M DCIs and the M scrambled CRC on M PDCCHs, respectively (block 1116) (see e.g., events 528, 536, 542, 546). Then the base station or DU transmits M PDSCH transmissions of the M PDUs via unicast in accordance with the M DCIs, respectively (block 1119) (see e.g., events 528, 536, 542, 546). In this manner, the first set of M UEs corresponding to the M C-RNTIs receive the MBS data packet. Blocks 1107, 1109, 1110, 1113, 1114, 1116, and 1119 are collectively referred to in FIG. 11B as block 1191.

FIG. 11C illustrates an example method 1100C that includes similar steps for transmitting the data packet received via the first DL tunnel as in the method 1000C when the data packet was received via the second DL tunnel. More specifically, in response to determining that the DL tunnel is a first DL tunnel, the base station or DU determines (e.g., identifies or selects) a first logical channel ID (block 1106). The base station or DU then generates a PDU (e.g., a MAC PDU) that includes the first logical channel ID and the data packet (block 1108) (see e.g., events 528, 536, 542, 546). The base station or DU also determines (e.g., identifies or selects) M C-RNTIs for identifying a first set of M UEs, respectively (e.g., the second set of UEs in method 700 for receiving the PDU from the first DL tunnel via unicast) (block 1110). The base station or DU then generates a single DCI and a single CRC for the DCI to schedule a PDSCH transmission of the PDU (block 1111) (see e.g., events 528, 536, 542, 546). Then the base station or DU scrambles the CRC with each of the M C-RNTIs to obtain M scrambled CRCs (block 1115) (see e.g., events 528, 536, 542, 546). The base station or DU transmits the DCI and the M scrambled CRCs on M PDCCHs, respectively (block 1117) (see e.g., events 528, 536, 542, 546). Then the base station or DU transmits a PDSCH transmission of the PDU via unicast in accordance with the DCI (block 1122) (see e.g., events 528, 536, 542, 546). In this manner, the first set of M UEs corresponding to the M C-RNTIs receive the MBS data packet. Blocks 1106, 1108, 1110, 1111, 1115, 1117, and 1122 are collectively referred to in FIG. 11C as block 1192.

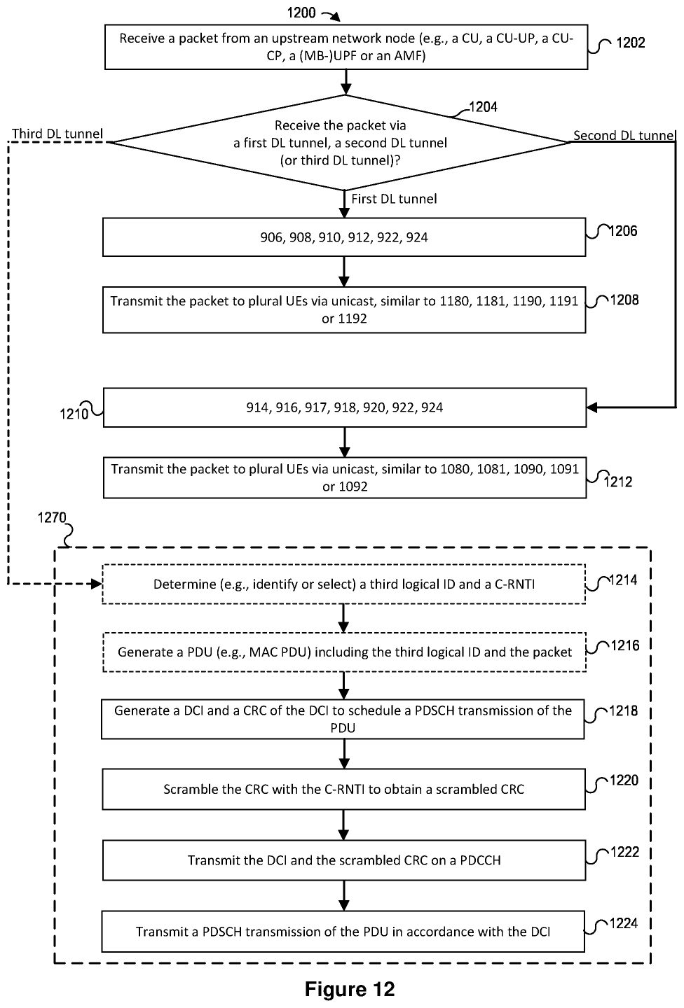

FIG. 12 illustrates an example method 1200 similar to method 700 except that in the method 1200, when the tunnel via which the data packet was received is the third DL tunnel, the base station or DU identifies a C-RNTI for transmitting the data packet to a particular legacy UE corresponding to the C-RNTI via non-MBS unicast.

In response to determining that the DL tunnel is a third DL tunnel, the base station or DU determines (e.g., identifies or selects) a third logical channel ID and a C-RNTI corresponding to the particular UE from the method 700 (block 1214). The base station or DU then generates a PDU (e.g., a MAC PDU) that includes the third logical channel ID and the data packet (block 1216) (see e.g., events 528, 536, 542, 546). The base station or DU also generates a DCI and a CRC of the DCI to schedule a PDSCH transmission of the PDU (block 1210) (see e.g., events 528, 536, 542, 546). Then the base station or DU scrambles the CRC with the C-RNTI to obtain a scrambled CRC (block 1212) (see e.g., events 528, 536, 542, 546). The base station or DU transmits the DCI and the scrambled CRC on a PDCCH (block 1214), and transmits a PDSCH transmission of the PDU via unicast in accordance with the DCI (block 1216) (see e.g., events 528, 536, 542, 546). In this manner, the particular legacy UE corresponding to the C-RNTI receives the data packet. Blocks 1214, 1216, 1218, 1220, 1222, and 1224 are collectively referred to in FIG. 12 as block 1270.

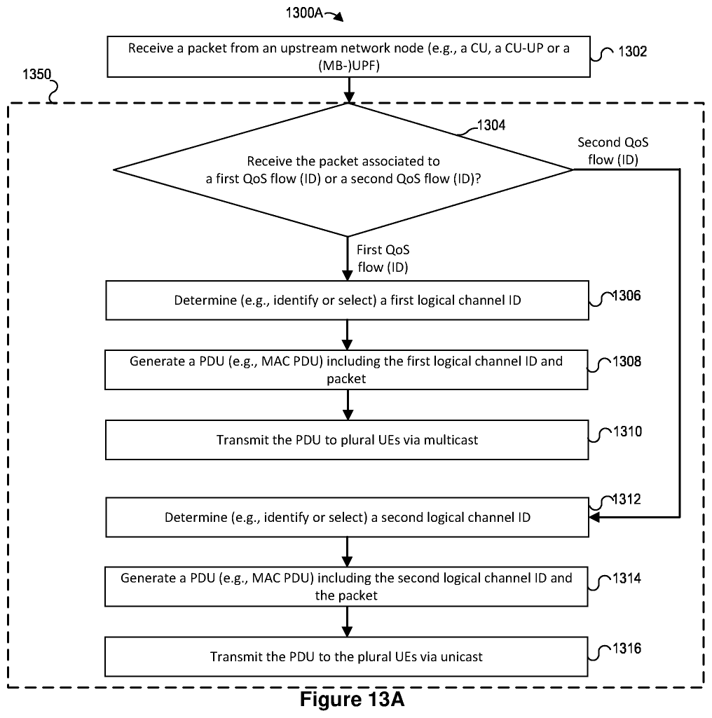

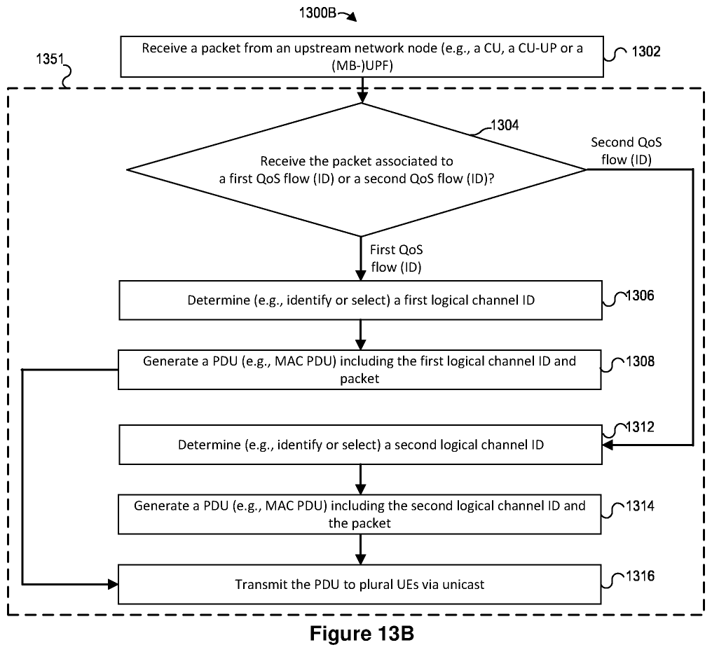

In some implementations, in addition or as an alternative to determining the tunnel via which a data packet was received, the base station 104 or the DU 174 determines a QoS flow associated with the data packet. FIG. 13A illustrates an example method 1300A for determining which logical channel to use and whether to transmit an MBS data packet via unicast or multicast based on an MBS QoS flow ID associated with the MBS data packet.

At block 1302, the base station or DU receives a data packet from an upstream network node (e.g., a CU, a CU-UP, an (MB-) UPF, etc.) which is associated with a QoS flow (see e.g., events 524, 526, 532, 534, 538, 540, 544). In some implementations, the base station or the DU can receive, from the upstream network node, AMF or CU-CP, first Qos information (e.g., first QoS flow ID) associated with the first QoS flow and second QoS information (e.g., second QoS flow ID) associated with the second QoS flow before block 1302 (see e.g., events 504, 506, 512, 514, 586, 587, 589). In some implementations, base station or CU receives the first QoS information and/or second QoS information from the AMF in at least one CN-to-BS message. For example, the at least one CN-to-BS message includes an MBS session resource setup request message (e.g., event 504), UE associated CN-to-BS message(s) (e.g., events 512, 532) and/or non-UE-associated CN-to-BS message(s) (e.g., event 512).

Also in some implementations, the DU receives the first QoS information and/or the second QoS information in at least one CU-to-DU message from the CU. For example, the at least one CU-to-DU message includes an MBS Context Request message (e.g., event 506) and/or UE associated CU-to-DU message(s) (e.g., events 514, 534).

Then the base station or the DU receives a container packet (e.g., a tunnel packet or a GTP-U packet) including QoS information (e.g., a QoS flow ID) and the data packet from the CN. If the QoS information is first QoS information having a first QoS flow ID, the base station or the DU determines that the data packet is associated with the first QoS flow (block 1304). If the QoS information is second QoS information having a second QoS flow ID, the base station or the DU determines that the data packet is associated with the second QoS flow (block 1304).

Then the base station or DU identifies UEs to transmit the data packet via multicast and/or UE(s) to transmit the data packet via unicast based on the QoS flow associated with the data packet. For example, the base station or DU can maintain a table or mapping from the QoS information received from the CU indicating for each QoS flow, whether to transmit the data packet to UEs via multicast or unicast, a logical channel ID corresponding to the QoS flow, a set of UEs for receiving the MBS data packet via multicast (e.g., as indicated by a G-RNTI), a set of UEs for receiving the MBS data packet via unicast (e.g., as indicated by C-RNTIs), etc.

In response to determining that the QoS information has a first QoS flow ID for a first QoS flow, the base station or DU determines (e.g., identifies or selects) a first logical channel ID (block 1306). The base station or DU then generates a PDU (e.g., a MAC PDU) that includes the first logical channel ID and the data packet (block 1308) (see e.g., events 528, 536, 542, 546). Then the base station or DU transmits the PDU to a set of UEs via an MBS multicast data transmission (block 1310) (see e.g., events 528, 536, 542, 546). If the packet is too large to be included in a payload of the PDU, the base station or the DU can include a portion of the packet in the PDU. Then the base station or the DU can generate another PDU (i.e., a second PDU, e.g., a MAC PDU) including the first logical channel ID and another portion of the packet and transmit the other PDU to the set of UEs (see e.g., events 528, 536, 542, 546).

In response to determining that the QoS information has a second QoS flow ID for a second QoS flow, the base station or DU determines (e.g., identifies or selects) a second logical channel ID (block 1312). The base station or DU then generates a PDU (e.g., a MAC PDU) that includes the second logical channel ID and the data packet (block 1314) (see e.g., events 528, 536, 542, 546). Then the base station or DU transmits the PDU to the same set of UEs via MBS unicast data transmissions (block 1316) (see e.g., events 528, 536, 542, 546). If the packet is too large to be included in a payload of the PDU, the base station or the DU can include a portion of the packet in the PDU (see e.g., events 528, 536, 542, 546). Then the base station or the DU can generate another PDU (i.e., a second PDU, e.g., a MAC PDU) including the second logical channel ID and another portion of the packet and transmit the other PDU to the set of UEs (see e.g., events 528, 536, 542, 546). In this manner, the QoS flow ID may indicate to the base station or the DU whether to transmit the data packet to the UEs via multicast or unicast. Blocks 1304, 1306, 1308, 1310, 1312, 1314, and 1316 are collectively referred to in FIG. 13A as block 1350.

The example method 1300A may be applied to the first set of UEs in the example method 600. For example, in a first instance, the QoS flow ID may be the first QoS flow ID. In response to determining that the QoS information includes the first QoS ID, the base station or DU transmits the data packet to the first set of UEs via a multicast data transmission. In a second instance, the QoS flow ID may be the second QoS flow ID. In response to determining that the QoS information includes the second QoS ID, the base station or DU transmits the data packet to the first set of UEs via unicast data transmissions. The example method 1300A may also be applied to the second set of UEs in the example method 600. For example, in a third instance, the QoS flow ID may be the first QoS flow ID. In response to determining that the QoS information includes the first QoS ID, the base station or DU transmits the data packet to the second set of UEs via a multicast data transmission. In a fourth instance, the QoS flow ID may be the second QoS flow ID. In response to determining that the QoS information includes the second QoS ID, the base station or DU transmits the data packet to the second set of UEs via unicast data transmissions. More generally, the example method 1300A may be applied to any suitable set of UEs, including the third and/or fourth set of UEs in the example method 600.

FIG. 13B illustrates an example method 1300B similar to method 1300B except that in the method 1300B, the base station or DU transmits the MBS data packet via unicast when the data packet is associated with either the first or the second QoS flow.

In response to determining that the QoS information has a first QoS flow ID for a first QoS flow, the base station or DU determines (e.g., identifies or selects) a first logical channel ID (block 1306). The base station or DU then generates a PDU (e.g., a MAC PDU) that includes the first logical channel ID and the data packet (block 1308). Then the base station or DU transmits the PDU to a set of UEs via MBS unicast data transmissions (block 1316).

In response to determining that the QoS information has a second QoS flow ID for a second QoS flow, the base station or DU determines (e.g., identifies or selects) a second logical channel ID (block 1312). The base station or DU then generates a PDU (e.g., a MAC PDU) that includes the second logical channel ID and the data packet (block 1314). Then the base station or DU transmits the PDU to the same set of UEs via MBS unicast data transmissions (block 1316). Blocks 1304, 1306, 1308, 1312, 1314, and 1316 are collectively referred to in FIG. 13B as block 1351.

The example method 1300B may be applied to the second or fourth set of UEs in the example method 600, for example.

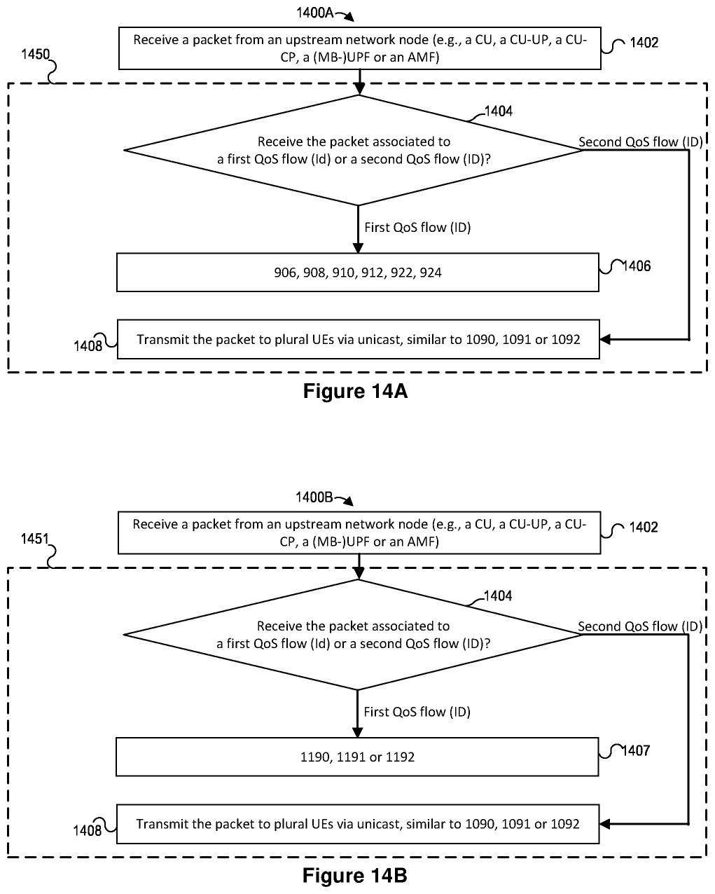

FIG. 14A illustrates an example method 1400A similar to method 1300A except that in the method 1400A, the base station or DU identifies a G-RNTI for transmitting the MBS data packet to UEs corresponding to the G-RNTI via multicast, and identifies C-RNTIs for transmitting the MBS data packet to UEs corresponding to the C-RNTIs via unicast.

In response to determining that the DL tunnel is a first DL tunnel, the base station or DU performs some of the same steps as in the method 900 (blocks 906, 908, 910, 912, 922, and 924) to transmit the MBS data packet to the set of UEs via multicast. In response to determining that the DL tunnel is a second DL tunnel, the base station or DU performs some of the same steps as in one of the methods 1000A, 1000B, 1000C (blocks 1090, 1091, or 1092) to transmit the MBS data packet to the set of UEs via unicast.

The example method 1400A may be applied to the first set of UEs in the example method 600. More generally, the example method 1400A may be applied to any suitable set of UEs, including the second, third, and/or fourth set of UEs in the example method 600.

FIG. 14B illustrates an example method 1400B similar to method 1300B except that in the method 1400B, the base station or DU identifies C-RNTIs for transmitting the MBS data packet to UEs corresponding to the C-RNTIs via unicast.

In response to determining that the DL tunnel is a first DL tunnel, the base station or DU performs some of the same steps as in one of the methods 1100A, 1100B, 1100C (blocks 1190, 1191, or 1192) to transmit the MBS data packet to the set of UEs via unicast. In response to determining that the DL tunnel is a second DL tunnel, the base station or DU performs some of the same steps as in one of the methods 1000A, 1000B, 1000C (blocks 1090, 1091, or 1092) to transmit the MBS data packet to the set of UEs via unicast.

The example method 1400B may be applied to the second or fourth set of UEs in the example method 600, for example.

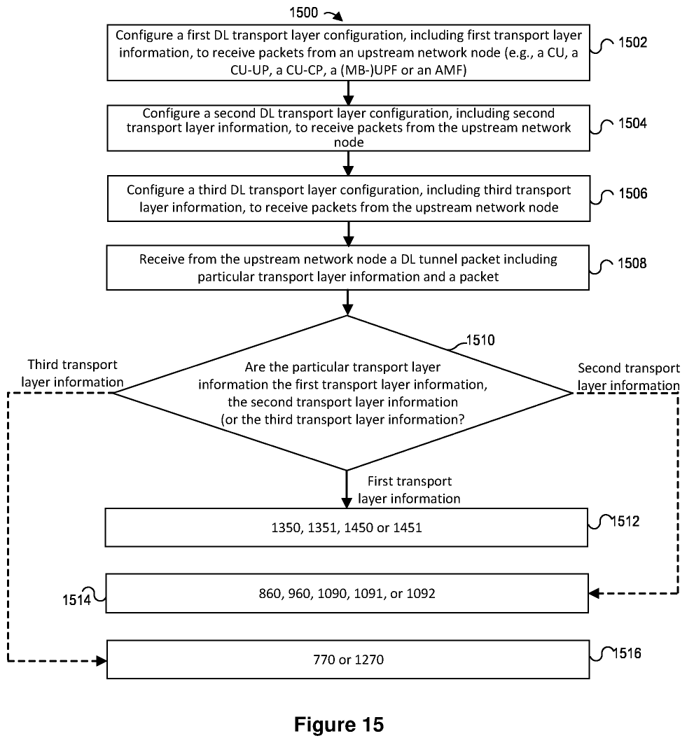

In some implementations, as mentioned above, the base station may configure DL transport layer configurations corresponding to common DL tunnels for receiving MBS data packets from the CN. FIG. 15 illustrates an example method 1500 for configuring DL transport layer configurations and identifying UEs to transmit an MBS data packet via multicast and/or identifying UE(s) to transmit the MBS data packet via unicast based on particular transport layer information associated with the MBS data packet.

At block 1502, the base station or DU configures a first DL transport layer configuration including first transport layer information for receiving packets from an upstream network node, such as a CU, a CU-UP, a CU-CP, an MB-UPF or an AMF (see e.g., events 502, 518, 524, 526, 530, 531, 532, 534, 538, 540, 544, 590). For example, in response to receiving a CU-to-DU message including an MBS Context Setup Request, the DU sends to the CU, a DU-to-CU message (e.g., an MBS Context Setup Response message) including a first DL transport layer configuration to configure a common CU-to-DU DL tunnel for the first MBS session (e.g., event 508). In some implementations, the DU-to-CU message is a generic F1AP message or a dedicated F1AP message defined specifically for this purpose (e.g., an MBS Context Setup Response message).

The CU 172 can then send a first BS-to-CN message (e.g., an MBS Session Resource Setup Response message) including the first DL transport layer configuration to configure the first common DL tunnel (e.g., event 510). The CU 172 can include a first MBS session ID and/or a first PDU session ID in the first BS-to-CN message. The first BS-to-CN message can include the first DL transport layer configuration to configure the first common DL tunnel for the CN 110 to send MBS data to the CU 172. The first DL transport layer configuration includes a first transport layer address (e.g., an IP address and/or a TEID) to identify the first common DL tunnel.

At block 1504, the base station or DU configures a second DL transport layer configuration including second transport layer information for receiving packets from an upstream network node, such as a CU, a CU-UP, a CU-CP, an MB-UPF or an AMF. For example, in response to receiving a CU-to-DU message including an MBS Context Setup Request, the DU sends to the CU, a DU-to-CU message (e.g., an MBS Context Setup Response message) including a second DL transport layer configuration to configure a common CU-to-DU DL tunnel for a second MBS session (e.g., event 508). Each of the DL transport layer configurations can be associated with a different MBS session. In some implementations, the DU-to-CU message is a generic FLAP message or a dedicated F1AP message defined specifically for this purpose (e.g., an MBS Context Setup Response message).

The CU 172 can then send a first BS-to-CN message (e.g., an MBS Session Resource Setup Response message) including the second DL transport layer configuration to configure the second common DL tunnel (e.g., event 510). The CU 172 can include a second MBS session ID and/or a second PDU session ID in the first BS-to-CN message. The first BS-to-CN message can include the second DL transport layer configuration to configure the second common DL tunnel for the CN 110 to send MBS data to the CU 172. The second DL transport layer configuration includes a second transport layer address (e.g., an IP address and/or a TEID) to identify the second common DL tunnel. The first and second transport layer configurations can be different to distinguish between first and second common DL tunnels. In particular, any pair of the first and second transport layer configurations can have different IP addresses, different DL TEIDs, or different IP addresses as well as different DL TEIDs.

At block 1506, the base station or DU configures a third DL transport layer configuration including third transport layer information for receiving packets from an upstream network node, such as a CU, a CU-UP, a CU-CP, an MB-UPF or an AMF. For example, in response to receiving a CU-to-DU message including an MBS Context Setup Request, the DU sends to the CU, a DU-to-CU message (e.g., an MBS Context Setup Response message) including a third DL transport layer configuration to configure a common CU-to-DU DL tunnel for a third MBS session (e.g., event 508). Each of the DL transport layer configurations can be associated with a different MBS session. In some implementations, the DU-to-CU message is a generic F1AP message or a dedicated F1AP message defined specifically for this purpose (e.g., an MBS Context Setup Response message).

The CU 172 can then send a first BS-to-CN message (e.g., an MBS Session Resource Setup Response message) including the third DL transport layer configuration to configure the third common DL tunnel (e.g., event 510). The CU 172 can include a third MBS session ID and/or a third PDU session ID in the first BS-to-CN message. The first BS-to-CN message can include the third DL transport layer configuration to configure the third common DL tunnel for the CN 110 to send MBS data to the CU 172. The third DL transport layer configuration includes a third transport layer address (e.g., an IP address and/or a TEID) to identify the third common DL tunnel. The first, second, and third transport layer configurations can be different to distinguish between first, second, and third common DL tunnels. In particular, any pair of the first, second, and third transport layer configurations can have different IP addresses, different DL TEIDs, or different IP addresses as well as different DL TEIDs.

At block 1508, the base station or DU receives a DL tunnel packet from an upstream network node (e.g., a CU, a CU-UP, an (MB-) UPF, etc.) via a certain DL tunnel. The DL tunnel packet includes transport layer information for a particular transport layer configuration and an MBS data packet. The base station or DU can determine to which transport layer configuration and DL tunnel a data packet corresponds based on the IP address and the TEID or other suitable transport-layer information included in the header of the DL tunnel packet. In some implementations, the first transport layer information includes a first transport layer address (e.g., an IP address) and/or a first DL tunnel ID (e.g., GTP-U tunnel ID). In some implementations, the second transport layer information include a second transport layer address (e.g., an IP address) and/or a second DL tunnel ID (e.g., GTP-U tunnel ID). In some implementations, the third transport layer information include a third transport layer address (e.g., an IP address) and/or a third DL tunnel ID (e.g., GTP-U tunnel ID).

In some implementations, the first, second and third transport layer information are different. For example, the first transport layer address and/or the first tunnel ID can be different from the second transport layer address and/or second tunnel ID. In cases where the first and second transport layer addresses are the same, the first and second tunnel IDs are different. In cases where the first and second tunnel IDs are the same, the first and second transport layer addresses are different.

At block 1510, the base station or DU identifies the transport layer information included in the header of the DL tunnel packet and determines the DL tunnel from which the data packet was received based on the transport layer information. For example, the base station or DU identifies the transport layer information as first transport layer information, second transport layer information, or third transport layer information. If the transport layer information is first transport layer information, the base station or DU determines that the data packet was received via the first DL tunnel. If the transport layer information is second transport layer information, the base station or DU determines that the data packet was received via the second DL tunnel. If the transport layer information is third transport layer information, the base station or DU determines that the data packet was received via the third DL tunnel, etc.

Then the base station or DU identifies UEs to transmit the data packet via multicast and/or UE(s) to transmit the data packet via unicast based on the DL tunnel via which the data packet was received. For example, the base station or DU can maintain a table or mapping indicating for each active DL tunnel, a set of UEs for receiving the MBS data packet via multicast (e.g., as indicated by a G-RNTI), a set of UEs for receiving the MBS data packet via unicast (e.g., as indicated by C-RNTIs), an individual legacy UE for receiving the MBS data packet via unicast (e.g., as indicated by a C-RNTI), logical channel IDs corresponding to the DL tunnel, an MRB for the DL tunnel, a DRB for the DL tunnel, etc.

In response to determining that the transport layer information is first transport layer information, the base station or DU performs some of the same steps as in one of the methods 1300A, 1300B, 1400A, 1400B (blocks 1350, 1351, 1450, or 1451) to transmit the MBS data packet to a set of UEs. As in the methods 1300A, 1300B, 1400A, 1400B, the base station or DU may transmit the MBS data packet to a first and/or second set of UEs via multicast or unicast depending on a QoS flow associated with the MBS data packet, or may transmit the MBS data packet to the first and/or second set of UEs via unicast regardless of the QoS flow associated with the MBS data packet.

In response to determining that the transport layer information is second transport layer information, the base station or DU performs some of the same steps as in one of the methods 800, 900, 1000A, 1000B, 1000C (blocks 860, 960, 1090, 1091, or 1092) to transmit the MBS data packet to a third set of UEs via multicast and/or a fourth set of UEs via unicast.

In response to determining that the transport layer information is third transport layer information, the base station or DU performs some of the same steps as in one of the methods 700, 1200 (blocks 770 or 1270) to transmit the data packet to a particular legacy UE via unicast.

The following list of examples reflects additional embodiments explicitly contemplated by the present disclosure.

Example 1. A method in a base station for managing multicast and unicast data transmissions, the method comprising: receiving, by processing hardware from a core network (CN), a multicast and/or broadcast services (MBS) downlink data packet via a downlink tunnel; determining, by the processing hardware, whether to transmit the MBS downlink data packet to a plurality of UEs via unicast or multicast; and at least one of: transmitting, by the processing hardware, the MBS downlink data packet to a plurality of first UEs via a multicast data transmission; or transmitting, by the processing hardware, the MBS downlink data packet to a plurality of second UEs via a plurality of unicast data transmissions.

Example 2. The method according to example 1, wherein determining whether to transmit the MBS downlink data packet via unicast or multicast includes: determining, by the processing hardware, whether to transmit the MBS downlink data packet to the plurality of UEs via unicast or multicast based on identification information for the downlink tunnel.

Example 3. The method according to any of the preceding examples, wherein the downlink tunnel is a first downlink tunnel, and wherein transmitting the MBS downlink data packet to the plurality of first UEs or transmitting the MBS downlink data packet to the plurality of second UEs includes: in response to determining that the downlink tunnel is the first downlink tunnel: transmitting, by the processing hardware, the MBS downlink data packet to the plurality of first UEs via the multicast data transmission based on identification information for the first downlink tunnel; and transmitting, by the processing hardware, the MBS downlink data packet to the plurality of second UEs via the plurality of unicast data transmissions based on identification information for the first downlink tunnel.

Example 4. The method according to any of the preceding examples, wherein the downlink tunnel is the first downlink tunnel in a first instance, the downlink tunnel is a second downlink tunnel in a second instance, the multicast data transmission is a first multicast data transmission, the plurality of unicast data transmissions are a first plurality of unicast data transmissions, and further comprising in the second instance: in response to determining that the downlink tunnel is the second downlink tunnel: transmitting, by the processing hardware, the MBS downlink data packet to a plurality of third UEs via a second multicast data transmission based on the identification information for the second downlink tunnel; and transmitting, by the processing hardware, the MBS downlink data packet to a plurality of fourth UEs via a second plurality of unicast data transmissions based on the identification information for the second downlink tunnel.

Example 5. The method according to any of the preceding examples, further comprising: receiving, by the processing hardware from the CN, a downlink data packet via a third downlink tunnel; determining, by the processing hardware, to transmit the downlink data packet to a particular UE; and transmitting, by the processing hardware, the downlink data packet to a particular UE via a third unicast data transmission.

Example 6. The method according to any of the preceding examples, further comprising: determining, by the processing hardware, a logical channel ID and a cell radio network temporary identifier (C-RNTI) corresponding to the particular UE; and generating, by the processing hardware, a protocol data unit (PDU) including the logical channel ID and the downlink data packet; generating, by the processing hardware, a DCI and a CRC of the DCI to schedule a PDSCH transmission of the PDU; scrambling, by the processing hardware, the CRC with the C-RNTI to obtain a scrambled CRC; and wherein transmitting the downlink data packet to the particular UE via the third unicast data transmission includes: transmitting, by the processing hardware, the DCI and the scrambled CRC to the particular UE on a PDCCH; and transmitting, by the processing hardware, the PDSCH transmission of the PDU to the particular UE in accordance with the DCI.

Example 7. The method according to any of the preceding examples, further comprising: storing, by the processing hardware, a mapping of tunnel identification information to one or more of: a logical channel ID, a multicast radio bearer (MRB), a data radio bearer (DRB), a C-RNTI, or a group RNTI (G-RNTI).

Example 8. The method according to any of the preceding examples, further comprising: determining, by the processing hardware, a logical channel ID based on the identification information for the downlink tunnel; and generating, by the processing hardware, a protocol data unit (PDU) including the logical channel ID and the MBS downlink data packet; wherein transmitting the MBS downlink data packet to the plurality of first UEs or transmitting the MBS downlink data packet to the plurality of second UEs includes: transmitting, by the processing hardware, the PDU to the plurality of first UEs via the multicast data transmission; or transmitting, by the processing hardware, the PDU to the plurality of second UEs via the plurality of unicast data transmissions.

Example 9. The method according to any of the preceding examples, wherein transmitting the PDU to the plurality of second UEs via the plurality of unicast data transmissions includes: determining, by the processing hardware, a plurality of logical channel IDs for the plurality of second UEs, respectively; generating, by the processing hardware, a plurality of PDUs each including one of the plurality of logical channel IDs and the MBS downlink data packet; and transmitting, by the processing hardware, the plurality of PDUs to the plurality of second UEs via the plurality of unicast data transmissions.

Example 10. The method according to any of the preceding examples, further comprising: determining, by the processing hardware, a G-RNTI; generating, by the processing hardware, a downlink control information element (DCI) and a cyclic redundancy check (CRC) of the DCI to schedule a physical downlink shared channel (PDSCH) transmission of the PDU; scrambling, by the processing hardware, the CRC with the G-RNTI to obtain a scrambled CRC; and wherein transmitting the PDU to the plurality of first UEs includes: transmitting, by the processing hardware, the DCI and the scrambled CRC on a physical downlink control channel (PDCCH) to the plurality of first UEs; and transmitting, by the processing hardware, the PDSCH transmission of the PDU to the plurality of first UEs in accordance with the DCI.

Example 11. The method according to any of the preceding examples, further comprising: determining, by the processing hardware, a plurality of C-RNTIs for the plurality of second UEs, respectively; generating, by the processing hardware, a plurality of DCIs and a plurality of CRCs of the DCIs to schedule a plurality of PDSCH transmissions of the PDU corresponding to the respective plurality of second UEs; scrambling, by the processing hardware, the plurality of CRCs with the respective plurality of C-RNTIs to obtain a plurality of scrambled CRCs; and wherein transmitting the PDU to the plurality of second UEs via the plurality of unicast data transmissions includes: transmitting, by the processing hardware, the plurality of DCIs and the plurality of scrambled CRCs on a plurality of PDCCHs to the plurality of second UEs, respectively; and transmitting, by the processing hardware, the plurality of PDSCH transmissions of the PDU to the plurality of second UEs in accordance with the respective plurality of DCIs.

Example 12. The method according to any of the preceding examples, wherein: determining the logical channel ID includes determining, by the processing hardware, a plurality of logical channel IDs for the plurality of second UEs, respectively; generating the PDU includes generating, by the processing hardware, a plurality of PDUs each including one of the plurality of logical channel IDs and the MBS downlink data packet; and transmitting the plurality of PDSCH transmissions of the PDU includes transmitting, by the processing hardware, a plurality of PDSCH transmissions of the plurality of PDUs to the plurality of second UEs in accordance with the respective plurality of DCIs.

Example 13. The method according to any of the preceding examples, further comprising: determining, by the processing hardware, a plurality of C-RNTIs for the plurality of second UEs, respectively; generating, by the processing hardware, a DCI and a CRC of the DCI to schedule a PDSCH transmission of the PDU; scrambling, by the processing hardware, the CRC with the respective plurality of C-RNTIs to obtain a plurality of scrambled CRCs; and wherein transmitting the PDU to the plurality of second UEs via the plurality of unicast data transmissions includes: transmitting, by the processing hardware, the DCI and the plurality of scrambled CRCs on a plurality of PDCCHs to the plurality of second UEs, respectively; and transmitting, by the processing hardware, the PDSCH transmission of the PDU to the plurality of second UEs in accordance with the DCI.

Example 14. The method according to any of the preceding examples, further comprising: determining, by the processing hardware, a quality of service (QOS) flow ID associated with the MBS downlink data packet; and wherein determining whether to transmit the MBS downlink data packet to the plurality of UEs via unicast or multicast includes: determining, by the processing hardware, whether to transmit the MBS downlink data packet to the plurality of first UEs via the multicast data transmission or the plurality of unicast data transmissions based on the QoS flow ID; and/or determining, by the processing hardware, whether to transmit the MBS downlink data packet to the plurality of second UEs via the multicast data transmission or the plurality of unicast data transmissions based on the QoS flow ID.

Example 15. The method according to any of the preceding examples, wherein: determining whether to transmit the MBS downlink data packet to the plurality of first UEs via the multicast data transmission or the plurality of unicast data transmissions includes: in a first instance, determining, by the processing hardware, to transmit the MBS downlink data packet to the plurality of first UEs via the multicast data transmission based on the QoS flow ID being a first QoS flow ID; and in a second instance, determining, by the processing hardware, to transmit the MBS downlink data packet to the plurality of first UEs via a plurality of unicast data transmissions based on the QoS flow ID being a second QoS flow ID; and/or wherein determining whether to transmit the MBS downlink data packet to the plurality of second UEs via the multicast data transmission or the plurality of unicast data transmissions includes: in a third instance, determining, by the processing hardware, to transmit the MBS downlink data packet to the plurality of second UEs via the multicast data transmission based on the QoS flow ID being the first QoS flow ID; and in a fourth instance, determining, by the processing hardware, to transmit the MBS downlink data packet to the plurality of second UEs via the one or more unicast data transmissions based on the QoS flow ID being the second QoS flow ID.

Example 16. The method according to any of the preceding examples, further comprising: determining, by the processing hardware, a quality of service (QOS) flow ID associated with the MBS downlink data packet; and determining, by the one or more processors, a logical channel ID based on the QoS flow ID; generating, by the one or more processors, a PDU including the determined logical channel ID and the MBS downlink data packet; and wherein transmitting the MBS downlink data packet to the plurality of second UEs includes: transmitting, by the processing hardware, the PDU to the plurality of second UEs via the plurality of unicast data transmissions.

Example 17. The method according to any of the preceding examples, further comprising: configuring, by the processing hardware, one or more downlink transport layer configurations each including transport layer information for receiving MBS downlink data packets corresponding to a particular downlink tunnel; wherein receiving the MBS downlink data packet from the CN includes receiving, by the processing hardware from the CN, a downlink tunnel packet including the MBS downlink data packet and particular transport layer information; and in response to receiving the MBS downlink data packet via the downlink tunnel; identifying, by the processing hardware, the downlink tunnel based on the particular transport layer information and the one or more downlink transport layer configurations.

Example 18. A method in a base station for managing transmission of multicast and/or broadcast services (MBS), the method comprising: receiving, by processing hardware from a UE, a first request to join a first MBS session identified by a first MBS session identifier; receiving, by the processing hardware from the UE, a second request to join a second MBS session identified by a second MBS session identifier; transmitting, by the processing hardware to the UE, first MBS data for the first MBS session; and transmitting, by the processing hardware to the UE, second MBS data for the second MBS session during the first MBS session.

Example 19. The method according to example 18, further comprising: configuring, by the processing hardware, the first MBS session for transmitting the first MBS data via a first tunnel; and configuring, by the processing hardware, the second MBS session for transmitting the second MBS data via a second tunnel.

Example 20. The method according to either one of example 18 or example 19,wherein a configuration of the first or second MBS session includes at least one of: a quality of service configuration for the first or second MBS session, or a quality of service flow for the first or second MBS session.

Example 21. The method according to any one of examples 18-20, wherein a configuration of the first tunnel or a configuration of the second tunnel includes at least one of: a transport layer address, or a tunnel identifier.

Example 22. The method according to any one of examples 18-21, wherein configuring the first MBS session includes: performing, by the processing hardware with the CN. a first MBS session resource setup procedure.

Example 23. The method according to any one of examples 18-22, further comprising: performing, by the processing hardware with the UE, a UE-specific MBS session configuration procedure.

Example 24. The method according to any one of examples 18-23, wherein performing the first MBS session resource setup procedure includes: receiving, by the processing hardware, an MBS session resource setup request message from a core network (CN) including the first MBS session identifier; and transmitting, by the processing hardware, an MBS session resource setup response message including a transport layer configuration for the first MBS session.

Example 25. The method according to any one of examples 18-24, wherein performing the UE-specific MBS session configuration procedure includes: transmitting, by the processing hardware to the UE, a radio resource control (RRC) reconfiguration message including a multicast radio bearer (MRB) configuration); and receiving, by the processing hardware from the UE, an RRC reconfiguration complete message.

Example 26. The method according to any one of examples 18-25, wherein the UE is a first UE, and further comprising: receiving, by the processing hardware from a second UE, a third request to join the first MBS session identified by the first MBS session identifier; transmitting, by the processing hardware to the second UE, first MBS data for the first MBS session.

Example 27. A base station comprising processing hardware and configured to perform a method according to any of the preceding examples.

Example 28. A method in a UE for obtaining multicast and/or broadcast services (MBS) data from a plurality of MBS sessions, the method comprising: transmitting, by processing hardware to a base station, a first request to join a first MBS session identified by a first MBS session identifier; transmitting, by the processing hardware to the base station, a second request to join a second MBS session identified by a second MBS session identifier; receiving, by the processing hardware from the base station, first MBS data for the first MBS session; and receiving, by the processing hardware from the base station, second MBS data for the second MBS session during the first MBS session.

Example 29. The method according to example 28, further comprising: performing, by the processing hardware, a first MBS session join procedure for the first MBS session for receiving the first MBS data via a first tunnel; and performing, by the processing hardware, a second MBS session join procedure for the second MBS session for receiving the second MBS data via a second tunnel.

Example 30. The method according to example 28 or example 29, wherein a configuration of the first tunnel or a configuration of the second tunnel includes at least one of: a transport layer address, or a tunnel identifier.

Example 31. The method according to any of examples 28-30, further comprising: for each of the first and second MBS sessions, performing, by the processing hardware with the base station, a UE-specific MBS session configuration procedure.

Example 32. The method according to any of examples 28-31, wherein performing the UE-specific MBS session configuration procedure includes: receiving, by the processing hardware from the base station, a radio resource control (RRC) reconfiguration message including a multicast radio bearer (MRB) configuration); and transmitting, by the processing hardware to the base station, an RRC reconfiguration complete message.

Example 33. A UE comprising processing hardware and configured to perform a method according to any of examples 28-32.

The following additional considerations apply to the foregoing discussion.

In some implementations, “message” is used and can be replaced by “information element (IE)”. In some implementations, “IE” is used and can be replaced by “field”. In some implementations, “configuration” can be replaced by “configurations” or the configuration parameters. In some implementations, “MBS” can be replaced by “multicast” or “broadcast”.

A user device in which the techniques of this disclosure can be implemented (e.g., the UE 102A or 102B) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for communicating MBS information through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method in a central unit (CU) of a base station for managing multicast and unicast data transmissions, the method comprising:
transmitting, by the CU to a distributed unit (DU) of the base station, a multicast and/or broadcast services (MBS) context setup request message to request a set-up for an MBS context, wherein the MBS context setup request message includes an MBS session identifier and one or more multicast radio bearer (MRB) IDs;
receiving, at the CU from the DU, an MBS context setup response message in response to the MBS context setup request message;
receiving, by the CU from a core network (CN), an MBS downlink data packet; and
transmitting, by the CU, the MBS downlink data packet to the via a downlink tunnel to multicast the MBS downlink data packet to a plurality of first UEs via a multicast data transmission.

2. The method of claim 1, further comprising:
receiving, by the CU from the DU, a first transport layer configuration for the downlink tunnel.

3. A method in a distributed unit (DU) of a base station for managing transmission of multicast and/or broadcast services (MBS), the method comprising:
receiving, by the DU from a central unit (CU) of a base station, an MBS context setup request message to request a set-up for an MBS context, wherein the MBS context setup request message includes a first MBS session identifier and one or more multicast radio bearer (MRB) IDs;
transmitting, by the DU to the CU, an MBS context setup response message in response to the MBS context setup request message;
receiving, by the DU from the CU, first MBS data for a first MBS session via a first downlink tunnel; and
transmitting, by the DU to a first plurality of UEs, first MBS data for the first MBS session.

4. The method of claim 3, further comprising:
transmitting, by the DU to the CU, a first transport layer configuration for the first downlink tunnel;
receiving, by the DU from the CU, second MBS data for a second MBS session via a second downlink tunnel;
transmitting, by the DU to a second plurality of UEs, the second MBS data for the second MBS session; and transmitting, by the DU to the CU, a second transport layer configuration for the second downlink tunnel.

5. The method of claim 4, further comprising:
configuring, by the DU, the first transport layer for transmitting the first MBS data via the first downlink tunnel; and
configuring, by the DU, the second transport layer for transmitting the second MBS data via the second downlink tunnel, and wherein:
a configuration of the first or second transport layer includes at least one of:
a quality of service configuration for the first or second MBS session,
a quality of service flow for the first or second MBS session,
a transport layer address, or
a tunnel identifier.

6. The method of claim 3, further comprising:
receiving, by the DU from a second UE, a request to join the first MBS session identified by the first MBS session identifier;
transmitting, by the DU to the second UE, first MBS data for the first MBS session.

7. The method of claim 3, further comprising:
determining, by the DU, whether to transmit the first MBS data to the first plurality of UEs via unicast or multicast based on identification information for the first downlink tunnel;
in response to determining that the first downlink tunnel is identified by a first identifier:
transmitting, by the DU, the first MBS data to the first plurality of UEs via a multicast data transmission based on the identification information for the first downlink tunnel; and
transmitting, by the DU, the first MBS data to a second plurality of UEs via a plurality of unicast data transmissions based on the identification information for the first downlink tunnel;
wherein the first downlink tunnel is identified by the first identifier in a first instance, the first downlink tunnel is identified by a second identifier in a second instance, the multicast data transmission is a first multicast data transmission, the plurality of unicast data transmissions are a first plurality of unicast data transmissions, and further comprising in the second instance:
in response to determining that the first downlink tunnel is identified by the second identifier:
transmitting, by the DU, the first MBS data to a third plurality of UEs via a second multicast data transmission based on the second identifier for the first downlink tunnel; and
transmitting, by the DU, the first MBS data packet to a fourth plurality of UEs via a second plurality of unicast data transmissions based on the second identifier for the first downlink tunnel.

8. The method of claim 7, further comprising:
receiving, by the DU from the CU, a downlink data packet via a downlink tunnel identified by a third identifier;
transmitting, by the DU, the downlink data packet to a particular UE via a third unicast data transmission;
determining, by the DU, a logical channel ID and a cell radio network temporary identifier (C-RNTI) corresponding to the particular UE;
generating, by the DU, a protocol data unit (PDU) including the logical channel ID and the downlink data packet;
generating, by the DU, a DCI and a CRC of the DCI to schedule a PDSCH transmission of the PDU;
scrambling, by the DU, the CRC with the C-RNTI to obtain a scrambled CRC; and
wherein transmitting the downlink data packet to the particular UE via the third unicast data transmission includes:
transmitting, by the DU, the DCI and the scrambled CRC to the particular UE on a physical downlink control channel (PDCCH); and
transmitting, by the DU, the PDSCH transmission of the PDU to the particular UE in accordance with the DCI.

9. The method of claim 7, further comprising:
storing, by the DU, a mapping of tunnel identification information to one or more of:
a logical channel ID,
a multicast radio bearer (MRB),
a data radio bearer (DRB),
a C-RNTI, or
a group RNTI (G-RNTI).

10. The method of claim 7, further comprising:
determining, by the DU, a logical channel ID based on the identification information for the first downlink tunnel; and
generating, by the DU, a protocol data unit (PDU) including the logical channel ID and the first MBS data;
transmitting, by the DU, the PDU to the first plurality of UEs via the multicast data transmission;
transmitting, by the DU, the PDU to the second plurality of UEs via the plurality of unicast data transmissions; wherein transmitting the PDU to the second plurality of UEs via the plurality of unicast data transmissions includes:
determining, by the DU, a plurality of logical channel IDs for the second plurality of UEs, respectively;
generating, by the DU, a plurality of PDUs each including one of the plurality of logical channel IDs and the first MBS data; and
transmitting, by the DU, the plurality of PDUs to the second plurality of UEs via the plurality of unicast data transmissions.

11. The method of claim 10, further comprising:
determining, by the DU, a G-RNTI;
generating, by the DU, a DCI and a CRC of the DCI to schedule a PDSCH transmission of the PDU;
scrambling, by the DU, the CRC with the G-RNTI to obtain a scrambled CRC; and
wherein transmitting the PDU to the first plurality of UEs includes:
transmitting, by the DU, the DCI and the scrambled CRC on a PDCCH to the first plurality of UEs; and
transmitting, by the DU, the PDSCH transmission of the PDU to the first plurality of UEs in accordance with the DCI;
determining, by the DU, a plurality of C-RNTIs for the second plurality of UEs, respectively; and
at least one of:
(1) generating, by the DU, a plurality of DCIs and a plurality of CRCs of the DCIs to schedule a plurality of PDSCH transmissions of the PDU corresponding to the respective second plurality of UEs, and scrambling, by the DU, the plurality of CRCs with the respective plurality of C-RNTIs to obtain a plurality of scrambled CRCs, wherein transmitting the PDU to the second plurality of UEs via the plurality of unicast data transmissions includes transmitting, by the DU, the plurality of DCIs and the plurality of scrambled CRCs on a plurality of PDCCHs to the second plurality of UEs, respectively, and transmitting, by the DU, the plurality of PDSCH transmissions of the PDU to the second plurality of UEs in accordance with the respective plurality of DCIs; or
(2) generating, by the DU, a DCI and a CRC of the DCI to schedule a PDSCH transmission of the PDU, and scrambling, by the DU, the CRC with the respective plurality of C-RNTIs to obtain a plurality of scrambled CRCs, wherein transmitting the PDU to the second plurality of UEs via the plurality of unicast data transmissions includes transmitting, by the DU, the DCI and the plurality of scrambled CRCs on a plurality of PDCCHs to the second plurality of UEs, respectively, and transmitting, by the DU, the PDSCH transmission of the PDU to the second plurality of UEs in accordance with the DCI.

12. The method of claim 11, wherein:
determining the logical channel ID includes determining, by the DU, a plurality of logical channel IDs for the second plurality of UEs, respectively;
generating the PDU includes generating, by the DU, a plurality of PDUs each including one of the plurality of logical channel IDs and the first MBS data; and
transmitting the plurality of PDSCH transmissions of the PDU includes transmitting, by the DU, a plurality of PDSCH transmissions of the plurality of PDUs to the second plurality of UEs in accordance with the respective plurality of DCIs.

13. The method of claim 7, further comprising:
determining, by the DU, a quality of service (QoS) flow ID associated with the first MBS data; and
wherein determining whether to transmit the first MBS data to the first plurality of UEs via unicast or multicast includes:
determining, by the DU, whether to transmit the first MBS data to the first plurality of UEs via the multicast data transmission or the plurality of unicast data transmissions based on the QoS flow ID;
determining, by the DU, whether to transmit the first MBS data to the second plurality of UEs via the multicast data transmission or the plurality of unicast data transmissions based on the QoS flow ID, wherein determining whether to transmit the first MBS data to the first plurality of UEs via the multicast data transmission or the plurality of unicast data transmissions includes:
in a first instance, determining, by the DU, to transmit the first MBS data to the first plurality of first UEs via the multicast data transmission based on the QoS flow ID being a first QoS flow ID; and
in a second instance, determining, by the DU, to transmit the first MBS data t to the first plurality of UEs via a plurality of unicast data transmissions based on the QoS flow ID being a second QoS flow ID;
wherein determining whether to transmit the first MBS downlink data to the second plurality of UEs via the multicast data transmission or the plurality of unicast data transmissions includes:
in a third instance, determining, by the DU, to transmit the first MBS data to the second plurality of UEs via the multicast data transmission based on the QoS flow ID being the first QoS flow ID; and
in a fourth instance, determining, by the DU, to transmit the first MBS data to the second plurality of UEs via the one or more unicast data transmissions based on the QoS flow ID being the second QoS flow ID.

14. The method of claim 7, further comprising:
determining, by the DU, a quality of service (QOS) flow ID associated with the first MBS data;
determining, by the DU, a logical channel ID based on the QoS flow ID;
generating, by the DU, a PDU including the determined logical channel ID and the first MBS data; and
wherein transmitting the first MBS data to the second plurality of UEs includes:
transmitting, by the DU, the PDU to the second plurality of UEs via the plurality of unicast data transmissions.

15. A distributed unit (DU) of a base station comprising processing hardware and configured to:
receive, from a central unit (CU) of a base station, an MBS context setup request message to request a set-up for an MBS context, wherein the MBS context setup request message includes a first MBS session identifier and one or more multicast radio bearer (MRB) IDs;
transmit, to the CU, an MBS context setup response message in response to the MBS context setup request message;
receive, from the CU, first MBS data for a first MBS session via a first downlink tunnel; and
transmit, to a first plurality of UEs, first MBS data for the first MBS session.

16. The DU of claim 15, wherein the DU is further configured to:
transmit, to the CU, a first transport layer configuration for the first downlink tunnel;
receive, from the CU, second MBS data for a second MBS session via a second downlink tunnel;
transmit, to a second plurality of UEs, the second MBS data for the second MBS session; and
transmit, to the CU, a second transport layer configuration for the second downlink tunnel.

17. The DU of claim 16, wherein the DU is further configured to:
configure the first transport layer for transmitting the first MBS data via the first downlink tunnel; and
configure the second transport layer for transmitting the second MBS data via the second downlink tunnel, wherein:
a configuration of the first or second transport layer includes at least one of:
a quality of service configuration for the first or second MBS session,
a quality of service flow for the first or second MBS session,
a transport layer address, or
a tunnel identifier.

18. The DU of claim 15, wherein the DU is further configured to:
receive, from a second UE, a request to join the first MBS session identified by the first MBS session identifier; and
transmit, to the second UE, first MBS data for the first MBS session.

19. The DU of claim 15, wherein the DU is further configured to:
determine whether to transmit the first MBS data to the first plurality of UEs via unicast or multicast based on identification information for the first downlink tunnel;
in response to determining that the first downlink tunnel is identified by a first identifier:
transmit the first MBS data to the first plurality of UEs via a multicast data transmission based on the identification information for the first downlink tunnel; and
transmit the first MBS data to a second plurality of UEs via a plurality of unicast data transmissions based on the identification information for the first downlink tunnel;
wherein the first downlink tunnel is identified by the first identifier in a first instance, the first downlink tunnel is identified by a second identifier in a second instance, the multicast data transmission is a first multicast data transmission, the plurality of unicast data transmissions are a first plurality of unicast data transmissions, and further comprising in the second instance:
in response to determining that the first downlink tunnel is identified by the second identifier:
transmit the first MBS data to a third plurality of UEs via a second multicast data transmission based on the second identifier for the first downlink tunnel; and
transmit the first MBS data packet to a fourth plurality of UEs via a second plurality of unicast data transmissions based on the second identifier for the first downlink tunnel.

20. The DU of claim 19, wherein the DU is further configured to:
receive, from the CU, a downlink data packet via a downlink tunnel identified by a third identifier;
transmit the downlink data packet to a particular UE via a third unicast data transmission;
determine a logical channel ID and a cell radio network temporary identifier (C-RNTI) corresponding to the particular UE;
generate a protocol data unit (PDU) including the logical channel ID and the downlink data packet;
generate a DCI and a CRC of the DCI to schedule a PDSCH transmission of the PDU;
scramble the CRC with the C-RNTI to obtain a scrambled CRC; and
wherein to transmit the downlink data packet to the particular UE via the third unicast data transmission, the DU is configured to:
transmit the DCI and the scrambled CRC to the particular UE on a physical downlink control channel (PDCCH); and
transmit the PDSCH transmission of the PDU to the particular UE in accordance with the DCI.
